(19) United States
(12) Patent Application Publication
(10) Pub. No.: US 2026/0313541 A1
(43) Pub. Date: Oct. 8, 2026

(54) DYNAMIC MONITORING OF RETRANSMISSION SCHEDULING ACCORDING TO PACKET DELAY BUDGETS

(71) Applicant: QUALCOMM Incorporated, San Diego, CA (US)

(72) Inventors: Zhichao ZHOU, Beijing (CN); Ahmed ELSHAFIE, San Diego, CA (US); Mickael MONDET, Louannec (FR); Ravi AGARWAL, San Diego, CA (US)

(21) Appl. No.: 19/483,183

(22) PCT Filed: Jun. 27, 2023
(86) PCT No.: PCT/CN2023/102645

§ 371 Date: Nov. 10, 2025

(51) Int. Cl. H04W 52/02; H04L 1/18

(52) U.S. Cl. CPC H04W 52/0216; H04L 1/18; H04W 52/0235

(57) ABSTRACT

Methods, systems, and devices for wireless communications are described. A user equipment (UE) may transmit, to a network entity, a feedback message indicating that the UE unsuccessfully decoded a downlink message. In some cases, the downlink message may be associated with a traffic flow having a packet delay budget (PDB). The UE may switch a receiver of the UE to a sleep state after transmitting the feedback message based on the PDB of the traffic flow for the downlink message, signaling from the network entity, or both. Additionally, or alternatively, a UE may transmit, to a network entity, an uplink message associated with a traffic flow having a PDB. The UE may the switch a receiver of the UE to a sleep state after transmitting the uplink message based on the PDB of the traffic flow for the uplink message, signaling from the network entity, or both.

### CROSS REFERENCE

The present Application for Patent is a 371 national phase filing of International Patent Application No. PCT/CN2023/102645 by ZHOU et al., entitled “DYNAMIC MONITORING OF RETRANSMISSION SCHEDULING ACCORDING TO PACKET DELAY BUDGETS,” filed Jun. 27, 2023, assigned to the assignee hereof, and expressly incorporated by reference herein.

### FIELD OF TECHNOLOGY

The following relates to wireless communications, including dynamic monitoring of retransmission scheduling according to packet delay budgets.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dynamic monitoring of retransmission scheduling according to packet delay budgets (PDBs). For example, the described techniques provide for a user equipment (UE) to selectively receive or transmit retransmissions (e.g., when operating in a discontinuous reception (DRX) mode) based on whether a PDB associated with a traffic flow (e.g., an extended reality (XR) traffic flow) will be satisfied. For example, one or more downlink messages associated with a traffic flow having some PDB may be transmitted from a network entity to a UE, and the UE may transmit a feedback message, to the network entity, indicating whether the UE successfully decoded the one or more downlink messages. After transmitting the feedback message (e.g., and based on whether a downlink message was successfully decoded), the UE may switch a receiver of the UE to a sleep state based on the PDB of the traffic flow, signaling from the network entity, or both.

For example, in cases where the downlink message is unsuccessfully decoded, one or more retransmissions of the downlink message may fail to satisfy the PDB of the traffic flow, and the UE may accordingly transition to the sleep state (and remain in the sleep state) instead of waking to monitor for signaling scheduling a retransmission (or waking to receive the retransmission itself). That is, based on a determination, by either the UE or the network entity, that processing the retransmission will exceed the PDB of the traffic flow, the UE may remain in a sleep state (e.g., powering down one or more receivers, powering down one or more receive chains), thereby conserving power of the UE. In some aspects, the UE may transition to the sleep state after transmitting the feedback message and then receive a wake-up signal (WUS) indicating that a retransmission of the downlink message will satisfy the PDB, where the WUS indicates that the UE may wake up (e.g., switch one or more receiver or receive chains to an active state) to receive signaling scheduling the retransmission, or to receive the retransmission itself (e.g., the WUS may include scheduling parameters for the retransmission). In some other examples, the UE may be triggered to transition to (or remain in) the sleep state via a received WUS, where the WUS may cancel a retransmission if such retransmission will exceed the PDB. In any case, the PDB may be taken into account for determining whether the UE wakes from a sleep mode to receive a retransmission of a downlink message.

Additionally, or alternatively, a UE may transmit, to a network entity, one or more uplink messages associated with a traffic flow (e.g., an XR traffic flow) having a PDB. The UE may then switch a receiver of the UE to a sleep state after transmitting the one or more uplink messages based on the PDB of the traffic flow for the uplink message, signaling from the network entity, or both. For example, the UE may determine that one or more retransmissions of an uplink message (e.g., an uplink message that may not be successfully decoded at the network entity) may exceed the PDB of the traffic flow, and the UE may accordingly remain in the sleep state (e.g., instead of waking to monitor for signaling scheduling a retransmission of the uplink message), thereby enhancing the UE's ability to save power. In some aspects, the UE may signal, to the network entity, an indication of the PDB information associated with the uplink message. Additionally, or alternatively, the UE may transition to the sleep state after transmitting the one or more uplink messages, and the UE may receive a WUS that triggers the UE to wake up and transmit a retransmission (e.g., in cases where the retransmission will satisfy the PDB). As such, the PDB may be considered to determine whether the UE wakes from a sleep mode to transmit a retransmission of an uplink message.

A method for wireless communications at a UE is described. The method may include transmitting, to a network entity, a feedback message indicating unsuccessful decoding of a downlink message, the downlink message being associated with a traffic flow having a PDB and switching a receiver of the UE to a sleep state after transmitting the feedback message indicating the unsuccessful decoding, the receiver switching to the sleep state based on the PDB or signaling from the network entity, or both.

A UE for wireless communications is described. The UE may include one or more memories storing processor-executable code and one or more processors coupled with the one or more memories and individually or collectively operable to execute the code to cause the UE to transmit, to a network entity, a feedback message indicating unsuccessful decoding of a downlink message, the downlink message being associated with a traffic flow having a PDB and switch a receiver of the UE to a sleep state after transmitting the feedback message indicating the unsuccessful decoding, the receiver switching to the sleep state based on the PDB or signaling from the network entity, or both.

Another UE for wireless communications is described. The UE may include means for transmitting, to a network entity, a feedback message indicating unsuccessful decoding of a downlink message, the downlink message being associated with a traffic flow having a PDB and means for switching a receiver of the UE to a sleep state after transmitting the feedback message indicating the unsuccessful decoding, the receiver switching to the sleep state based on the PDB or signaling from the network entity, or both.

A non-transitory computer-readable medium storing code for wireless communications is described. The code may include instructions executable by one or more processors to transmit, to a network entity, a feedback message indicating unsuccessful decoding of a downlink message, the downlink message being associated with a traffic flow having a PDB and switch a receiver of the UE to a sleep state after transmitting the feedback message indicating the unsuccessful decoding, the receiver switching to the sleep state based on the PDB or signaling from the network entity, or both.

Some examples of the method, UEs, and non-transitory computer-readable medium described herein may further include operations, features, means, or instructions for receiving the signaling from the network entity prior to transmitting the feedback message, the signaling including an indication to switch the receiver to the sleep state immediately after transmitting the feedback message based on a processing time for a retransmission of the downlink message exceeding the PDB, where the receiver remains in the sleep state until one or more timers expire in accordance with the signaling.

In some examples of the method, UEs, and non-transitory computer-readable medium described herein, receiving the signaling may include operations, features, means, or instructions for receiving the signaling via downlink control information (DCI) that schedules the downlink message.

Some examples of the method, UEs, and non-transitory computer-readable medium described herein may further include operations, features, means, or instructions for receiving the signaling from the network entity prior to transmitting the feedback message, the signaling including an indication to switch the receiver to the sleep state immediately after transmitting the feedback message when the feedback message indicates the unsuccessful decoding, receiving, from the network entity, a WUS including an indication to switch the receiver to an awake state to monitor for a control message scheduling a retransmission of the downlink message and monitor for the retransmission of the downlink message based on a processing time for the retransmission of the downlink message satisfying the PDB, switching the receiver to the awake state in response to the WUS, receiving the control message scheduling the retransmission of the downlink message while a retransmission timer may be active, and receiving, from the network entity, the retransmission of the downlink message based on the receiver being in the awake state, where the retransmission may be received in accordance with the control message.

In some examples of the method, UEs, and non-transitory computer-readable medium described herein, the receiver may be switched to the awake state in accordance with an interval after receiving the WUS.

In some examples of the method, UEs, and non-transitory computer-readable medium described herein, receiving the signaling may include operations, features, means, or instructions for receiving a radio resource control (RRC) message or a medium access control-control element (MAC-CE), or both, indicating a configuration to switch the receiver to the sleep state immediately after transmitting the feedback message.

Some examples of the method, UEs, and non-transitory computer-readable medium described herein may further include operations, features, means, or instructions for receiving, from the network entity, a WUS including an indication to switch the receiver to an awake state to monitor for a retransmission of the downlink message based on a processing time for the retransmission of the downlink message satisfying the PDB, the WUS further indicating scheduling parameters for receiving the retransmission of the downlink message and receiving the retransmission of the downlink message based on the receiver being in the awake state and in accordance with the scheduling parameters.

In some examples of the method, UEs, and non-transitory computer-readable medium described herein, the receiver may be in an awake state immediately after transmitting the feedback message and while one or more timers may be active and the method, UEs, and non-transitory computer-readable medium may include further operations, features, means, or instructions for receiving the signaling from the network entity, the signaling including a WUS including an indication that a retransmission of the downlink message may be canceled based on a processing time for the retransmission of the downlink message exceeding the PDB, where the receiver may be switched to the sleep state in response to the WUS.

In some examples of the method, UEs, and non-transitory computer-readable medium described herein, the receiver may be in an awake state immediately after transmitting the feedback message and while one or more timers may be active and the method, UEs, and non-transitory computer-readable medium may include further operations, features, means, or instructions for receiving the signaling from the network entity, the signaling including an indication that a retransmission of the downlink message may be canceled based on the UE performing one or more measurements during at least one measurement gap and a processing time for the retransmission of the downlink message exceeding the PDB based on the one or more measurements, where the receiver may be switched to the sleep state in response to the signaling.

In some examples of the method, UEs, and non-transitory computer-readable medium described herein, the signaling includes DCI, or a WUS, or both.

Some examples of the method, UEs, and non-transitory computer-readable medium described herein may further include operations, features, means, or instructions for transmitting, to the network entity, an uplink message indicating that the UE may be to perform the one or more measurements, where the indication that the retransmission of the downlink message may be canceled may be in response to the uplink message.

In some examples of the method, UEs, and non-transitory computer-readable medium described herein, the uplink message requests that the retransmission of the downlink message be canceled based on the PDB.

In some examples of the method, UEs, and non-transitory computer-readable medium described herein, the receiver may be switched to the sleep state immediately after transmitting the uplink message.

Some examples of the method, UEs, and non-transitory computer-readable medium described herein may further include operations, features, means, or instructions for receiving, from the network entity, a message including an indication to select a measurement pattern from a set of measurement patterns based on the PDB, where the measurement pattern supports a processing time for the retransmission of the downlink message that satisfies the PDB.

A method for wireless communications at a UE is described. The method may include transmitting, to a network entity, an uplink message associated with a traffic flow having a PDB and switching a receiver of the UE to a sleep state after transmitting the uplink message, the receiver switching to the sleep state based on the PDB or signaling from the network entity, or both.

A UE for wireless communications is described. The UE may include one or more memories storing processor-executable code and one or more processors coupled with the one or more memories and individually or collectively operable to execute the code to cause the UE to transmit, to a network entity, an uplink message associated with a traffic flow having a PDB and switch a receiver of the UE to a sleep state after transmitting the uplink message, the receiver switching to the sleep state based on the PDB or signaling from the network entity, or both.

Another UE for wireless communications is described. The UE may include means for transmitting, to a network entity, an uplink message associated with a traffic flow having a PDB and means for switching a receiver of the UE to a sleep state after transmitting the uplink message, the receiver switching to the sleep state based on the PDB or signaling from the network entity, or both.

A non-transitory computer-readable medium storing code for wireless communications is described. The code may include instructions executable by one or more processors to transmit, to a network entity, an uplink message associated with a traffic flow having a PDB and switch a receiver of the UE to a sleep state after transmitting the uplink message, the receiver switching to the sleep state based on the PDB or signaling from the network entity, or both.

Some examples of the method, UEs, and non-transitory computer-readable medium described herein may further include operations, features, means, or instructions for transmitting, to the network entity, a control signal including an indication that the receiver will switch to the sleep state immediately after transmitting the uplink message based on a processing time for a retransmission of the uplink message exceeding the PDB, where the receiver remains in the sleep state until one or more timers expire based on the PDB.

In some examples of the method, UEs, and non-transitory computer-readable medium described herein, transmitting the control signal may include operations, features, means, or instructions for transmitting the control signal via uplink control information (UCI), where the indication includes a one-bit indicator included in the UCI.

In some examples of the method, UEs, and non-transitory computer-readable medium described herein, the UCI may be multiplexed with the uplink message.

Some examples of the method, UEs, and non-transitory computer-readable medium described herein may further include operations, features, means, or instructions for receiving, from the network entity, a WUS including an indication that the uplink message was unsuccessfully decoded, switching the receiver to an awake state in response to the WUS, receiving, from the network entity, a control message scheduling a retransmission of the uplink message, the control message received based on monitoring a control channel for the control message while a retransmission timer may be active, and transmitting, to the network entity, the retransmission of the uplink message in accordance with the control message.

Some examples of the method, UEs, and non-transitory computer-readable medium described herein may further include operations, features, means, or instructions for determining to retransmit the uplink message as a full copy of the uplink message or a portion of the uplink message to be merged with the uplink message initially transmitted to the network entity, the determination being based on the PDB, where the retransmission of the uplink message including the full copy of the uplink message or the portion of the uplink message in accordance with the determination.

Some examples of the method, UEs, and non-transitory computer-readable medium described herein may further include operations, features, means, or instructions for receiving, from the network entity, a WUS including an indication to switch the receiver to an awake state to retransmit the uplink message based on a processing time for a retransmission of the uplink message satisfying the PDB, the WUS further indicating scheduling parameters for transmitting the retransmission of the uplink message and transmitting the retransmission of the uplink message based on the receiver being in the awake state and in accordance with the scheduling parameters.

In some examples of the method, UEs, and non-transitory computer-readable medium described herein, the receiver may be in an awake state immediately after transmitting the uplink message and while one or more timers may be active and the method, UEs, and non-transitory computer-readable medium may include further operations, features, means, or instructions for receiving the signaling from the network entity, the signaling including a WUS including an indication that a retransmission of the uplink message may be canceled based on a processing time for the retransmission of the uplink message exceeding the PDB, where the receiver may be switched to the sleep state in response to the WUS.

Some examples of the method, UEs, and non-transitory computer-readable medium described herein may further include operations, features, means, or instructions for transmitting, to the network entity, an indication of the PDB associated with the traffic flow, where the indication that the retransmission of the uplink message may be canceled may be based on the indication of the PDB.

A method for wireless communications at a network entity is described. The method may include transmitting, to a UE, a downlink message associated with a traffic flow having a PDB, transmitting, to the UE, signaling including an indication that the UE switch to a sleep state after transmitting a feedback message based on the PDB, and receiving, from the UE, the feedback message indicating unsuccessful decoding of the downlink message.

A network entity for wireless communications is described. The network entity may include one or more memories storing processor-executable code and one or more processors coupled with the one or more memories and individually or collectively operable to execute the code to cause the network entity to transmit, to a UE, a downlink message associated with a traffic flow having a PDB, transmit, to the UE, signaling including an indication that the UE switch to a sleep state after transmitting a feedback message based on the PDB, and receive, from the UE, the feedback message indicating unsuccessful decoding of the downlink message.

Another network entity for wireless communications is described. The network entity may include means for transmitting, to a UE, a downlink message associated with a traffic flow having a PDB, means for transmitting, to the UE, signaling including an indication that the UE switch to a sleep state after transmitting a feedback message based on the PDB, and means for receiving, from the UE, the feedback message indicating unsuccessful decoding of the downlink message.

A non-transitory computer-readable medium storing code for wireless communications is described. The code may include instructions executable by one or more processors to transmit, to a UE, a downlink message associated with a traffic flow having a PDB, transmit, to the UE, signaling including an indication that the UE switch to a sleep state after transmitting a feedback message based on the PDB, and receive, from the UE, the feedback message indicating unsuccessful decoding of the downlink message.

In some examples of the method, network entities, and non-transitory computer-readable medium described herein, transmitting the signaling may include operations, features, means, or instructions for transmitting the signaling to the UE prior to receiving the feedback message, the signaling including an indication to switch the receiver to the sleep state immediately after transmitting the feedback message based on a processing time for a retransmission of the downlink message exceeding the PDB.

In some examples of the method, network entities, and non-transitory computer-readable medium described herein, the signaling may be transmitted via DCI that schedules the downlink message.

In some examples of the method, network entities, and non-transitory computer-readable medium described herein, transmitting the signaling may include operations, features, means, or instructions for transmitting the signaling to the UE prior to receiving the feedback message, the signaling including an indication to switch to the sleep state immediately after transmitting the feedback message when the feedback message indicates the unsuccessful decoding, the method further including, transmitting, to the UE, a WUS including an indication to switch to an awake state to monitor for a control message scheduling a retransmission of the downlink message and monitor for the retransmission of the downlink message based on a processing time for the retransmission of the downlink message satisfying the PDB, transmitting the control message scheduling the retransmission of the downlink message while a retransmission timer may be active, and transmitting the retransmission of the downlink message to the UE in accordance with the control message.

In some examples of the method, network entities, and non-transitory computer-readable medium described herein, the retransmission of the downlink message may be transmitted in accordance with an interval after transmitting the WUS.

In some examples of the method, network entities, and non-transitory computer-readable medium described herein, transmitting the signaling may include operations, features, means, or instructions for transmitting a RRC message or a MAC-CE, or both, indicating a configuration to switch to the sleep state immediately after transmitting the feedback message.

Some examples of the method, network entities, and non-transitory computer-readable medium described herein may further include operations, features, means, or instructions for transmitting, to the UE, a WUS including an indication to switch to an awake state to monitor for a retransmission of the downlink message based on a processing time for the retransmission of the downlink message satisfying the PDB, the WUS further indicating scheduling parameters for receiving the retransmission of the downlink message and transmitting the retransmission of the downlink message in accordance with the scheduling parameters.

In some examples of the method, network entities, and non-transitory computer-readable medium described herein, the signaling includes a WUS including an indication that a retransmission of the downlink message may be canceled based on a processing time for the retransmission of the downlink message exceeding the PDB.

In some examples of the method, network entities, and non-transitory computer-readable medium described herein, the signaling includes an indication that a retransmission of the downlink message may be canceled based on the UE performing one or more measurements during at least one measurement gap and a processing time for the retransmission of the downlink message exceeding the PDB based on the one or more measurements.

A method for wireless communications at a network entity is described. The method may include receiving, from a UE, an uplink message associated with a traffic flow having a PDB and determining whether to transmit a downlink message scheduling a retransmission of the uplink message when the uplink message is unsuccessfully decoded, where the determining is based on the PDB of the traffic flow.

A network entity for wireless communications is described. The network entity may include one or more memories storing processor-executable code and one or more processors coupled with the one or more memories and individually or collectively operable to execute the code to cause the network entity to receive, from a UE, an uplink message associated with a traffic flow having a PDB and determine whether to transmit a downlink message scheduling a retransmission of the uplink message when the uplink message is unsuccessfully decoded, where the determining is based on the PDB of the traffic flow.

Another network entity for wireless communications is described. The network entity may include means for receiving, from a UE, an uplink message associated with a traffic flow having a PDB and means for determining whether to transmit a downlink message scheduling a retransmission of the uplink message when the uplink message is unsuccessfully decoded, where the determining is based on the PDB of the traffic flow.

A non-transitory computer-readable medium storing code for wireless communications is described. The code may include instructions executable by one or more processors to receive, from a UE, an uplink message associated with a traffic flow having a PDB and determine whether to transmit a downlink message scheduling a retransmission of the uplink message when the uplink message is unsuccessfully decoded, where the determining is based on the PDB of the traffic flow.

Some examples of the method, network entities, and non-transitory computer-readable medium described herein may further include operations, features, means, or instructions for receiving, from the UE, a control signal including an indication that the UE will switch to a sleep state immediately after transmitting the uplink message and until one or more timers expire based on a processing time for the retransmission of the uplink message exceeding the PDB and determining to refrain from transmitting the downlink message based on receiving the control signal.

In some examples of the method, network entities, and non-transitory computer-readable medium described herein, receiving the control signal may include operations, features, means, or instructions for receiving the control signal via UCI, where the indication includes a one-bit indicator included in the UCI.

In some examples of the method, network entities, and non-transitory computer-readable medium described herein, the UCI may be multiplexed with the uplink message.

Some examples of the method, network entities, and non-transitory computer-readable medium described herein may further include operations, features, means, or instructions for transmitting, to the UE, a WUS including an indication that the uplink message was unsuccessfully decoded, transmitting, to the UE, the downlink message scheduling the retransmission of the uplink message, the downlink message transmitted while a retransmission timer may be active at the UE, and receiving, from the UE, the retransmission of the uplink message in accordance with the downlink message.

In some examples of the method, network entities, and non-transitory computer-readable medium described herein, the retransmission of the uplink message includes a full copy of the uplink message or a portion of the uplink message to be merged with the uplink message initially transmitted by the UE based on the PDB.

Some examples of the method, network entities, and non-transitory computer-readable medium described herein may further include operations, features, means, or instructions for transmitting, to the UE, a WUS including an indication to switch to an awake state to retransmit the uplink message based on a processing time for the retransmission of the uplink message satisfying the PDB, the WUS further indicating scheduling parameters for transmitting the retransmission of the uplink message and receiving the retransmission of the uplink message in accordance with the scheduling parameters.

Some examples of the method, network entities, and non-transitory computer-readable medium described herein may further include operations, features, means, or instructions for transmitting signaling to the UE, the signaling including a WUS including an indication that the retransmission of the uplink message may be canceled based on a processing time for the retransmission of the uplink message exceeding the PDB.

Some examples of the method, network entities, and non-transitory computer-readable medium described herein may further include operations, features, means, or instructions for receiving, from the UE, an indication of the PDB associated with the traffic flow, where the indication that the retransmission of the uplink message may be canceled may be based on the indication of the PDB.

### BRIEF DESCRIPTION OF THE DRAWINGS

FIG. 1 shows an example of a wireless communications system that supports dynamic monitoring of retransmission scheduling according to packet delay budgets (PDBs) in accordance with one or more aspects of the present disclosure.

FIG. 2 through 6 show examples of wireless communications systems that support dynamic monitoring of retransmission scheduling according to PDBs in accordance with one or more aspects of the present disclosure.

FIGS. 7 and 8 show examples of process flows that supports dynamic monitoring of retransmission scheduling according to PDBs in accordance with one or more aspects of the present disclosure.

FIGS. 9 and 10 show block diagrams of devices that support dynamic monitoring of retransmission scheduling according to PDBs in accordance with one or more aspects of the present disclosure.

FIG. 11 shows a block diagram of a communications manager that supports dynamic monitoring of retransmission scheduling according to PDBs in accordance with one or more aspects of the present disclosure.

FIG. 12 shows a diagram of a system including a device that supports dynamic monitoring of retransmission scheduling according to PDBs in accordance with one or more aspects of the present disclosure.

FIGS. 13 and 14 show block diagrams of devices that support dynamic monitoring of retransmission scheduling according to PDBs in accordance with one or more aspects of the present disclosure.

FIG. 15 shows a block diagram of a communications manager that supports dynamic monitoring of retransmission scheduling according to PDBs in accordance with one or more aspects of the present disclosure.

FIG. 16 shows a diagram of a system including a device that supports dynamic monitoring of retransmission scheduling according to PDBs in accordance with one or more aspects of the present disclosure.

FIGS. 17 through 24 show flowcharts illustrating methods that support dynamic monitoring of retransmission scheduling according to PDBs in accordance with one or more aspects of the present disclosure.

### DETAILED DESCRIPTION

In some wireless communication systems, wireless devices (e.g., user equipments (UEs) and network entities) may transmit and receive extended reality (XR) data packets, and such wireless devices may accordingly be referred to as XR devices, or some similar terminology. XR traffic in a wireless communications system (e.g., a 5G system) may include virtual reality (VR) traffic, augmented reality (AR) traffic, mixed reality (MR) traffic, or any combination thereof, which may require relatively high reliability and low latency transmissions. In some examples, XR devices may face several challenges to be addressed before achieving increased commercialization and market penetration. Some of the challenges may include weight, processing complexity, and power consumption. For example, some XR devices may not be appropriate for extended-time and/or portable use scenarios, and a battery weight may be limited to reduce a total XR device weight. Processing complexity and power consumption may be limited due various factors, including a relatively reduced heat dissipation capacity (e.g., heat dissipation capacity of an XR device may be proportional to the surface size of the XR device (e.g., goggles, glasses)). For some XR devices (e.g., XR wearable goggles), power consumption may be limited to a few Watts (W) due to the limited heat dissipation capacity. Additionally, power consumption may be limited to allow a relatively lightweight battery that also provides a target battery duration. Therefore, constrained battery weight, processing complexity, and power consumption may result in challenges in view of the relatively heavy processing demands to support some XR applications.

XR traffic may include different traffic flows for downlink data and uplink data. In some cases, some of the XR traffic flows may have relatively limited packet delay budgets (PDBs), and wireless devices (e.g., UEs and network entities) may have difficulty meeting such PDBs (e.g., latency requirements), such as when there may be fluctuations in network capability. In some cases, the wireless devices may fail to decode the data from the traffic flow. As such, retransmissions may occur to aid in a wireless device successfully receiving and decoding a data packet of a given traffic flow.

Some wireless devices may use power-saving procedures to conserve power (e.g., by powering down one or more components of the wireless device, such as a receiver, one or more radio chains, or the like). As an example, a UE may use discontinuous reception (DRX) (e.g., connected mode discontinuous reception (CDRX)) techniques to transition to a sleep state when the UE is not transmitting or receiving data, thereby reducing power consumption of the UE. Here, the UE may periodically wake to monitor for indications of incoming data, or wake to transmit uplink data. For retransmissions in accordance with some DRX procedures (e.g., when data packets may be retransmitted during DRX operation), a wireless device may stay awake (e.g., be in an active state) during a retransmission timer (e.g., that is started after a round trip time (RTT) timer expires) to monitor for signaling (e.g., signaling via a physical downlink control channel (PDCCH)) that schedules a retransmission of a data packet. However, in cases with data packets associated with limited PDBs, there may be a relatively small amount of time, if any time, for a wireless device to receive or transmit the retransmitted data packet. In such cases, the wireless device may waste power waking to monitor for signaling while waiting for the timers to expire (e.g., waiting for the retransmission scheduling information). That is, if a retransmission will exceed a PDB of a traffic flow, and if the UE wakes for that retransmission, the UE may unnecessarily consume additional power. Moreover, even if a wireless device receives a retransmission of a data packet, there may be a relatively small amount time allocated to combine the retransmission with the initial transmission and decode the data packet. Therefore, some retransmissions may have a high probability of exceeding the PDB and may be unable to improve the transmission reliability and accuracy, particularly for XR traffic flows that have small PDBs.

As described herein, techniques may enable a wireless device (e.g., a UE, an XR device) to dynamically remain in a sleep state in cases where a retransmission of a data packet may exceed a PDB associated with a traffic flow (e.g., an XR traffic flow). In particular, when PDBs of a traffic flow may be relatively limited (e.g., a traffic flow has a low PDB) and retransmissions may be unobtainable, a network entity may indicate to a UE to go into a sleep state to save power at the UE rather than wait for a retransmission (e.g., when the UE may be unable to receive and decode the retransmission in accordance with the PDB). For example, the network entity may indicate to the UE to enter the sleep state immediately after transmitting a feedback message associated with decoding a first downlink message (e.g., the feedback message indicates whether the UE successfully decoded the first downlink message). In some cases, the UE may refrain from waking during a retransmission timer, thereby continuing in the sleep state and saving power. When a retransmission may be possible in accordance with the PDB, instead of having the UE wait for the retransmission, the UE may go to sleep after transmitting the feedback message and the network entity may transmit a wake-up signal (WUS) for the UE to wake up and receive the signaling scheduling the retransmission, or receive the retransmission itself (e.g., the WUS may include scheduling parameters for the retransmission). As such, the UE may receive the retransmission of the first downlink message while a retransmission timer remains active and there is time left in the PDB.

In some aspects, the UE may indicate, after or while transmitting uplink data to the network entity, that the UE may transition to the sleep state after transmitting the uplink data based on the time left in the PDB for the network entity to schedule a retransmission and for the UE to transmit the retransmission. Additionally, or alternatively, the WUS may be repurposed to indicate that the UE should go to sleep. For example, the network entity may transmit the WUS to the UE (e.g., a UE in an awake state) in cases where the network entity has to cancel a retransmission, and the UE may transition to the sleep state based on receiving the WUS indicating that the retransmission is canceled. As such, the techniques of the present disclosure describe enabling the UE to go to sleep during the RTT timer and the retransmission timers to provide enhanced power savings for the UE. In such cases, the UE may refrain from waiting for retransmissions during these timers unless indicated. Such techniques may save power at the UE when retransmissions will exceed a PDB, providing for improved power management compared to traditional techniques, where the UE may stay awake regardless of whether a PDB associated with a traffic flow (an XR traffic flow) can accommodate a retransmission.

Aspects of the disclosure are initially described in the context of wireless communications systems. Additional aspects of the disclosure are described herein with reference to wireless communications systems and process flows. Aspects of the disclosure are further illustrated by and described with reference to apparatus diagrams, system diagrams, and flowcharts that relate to dynamic monitoring of retransmission scheduling according to PDBs.

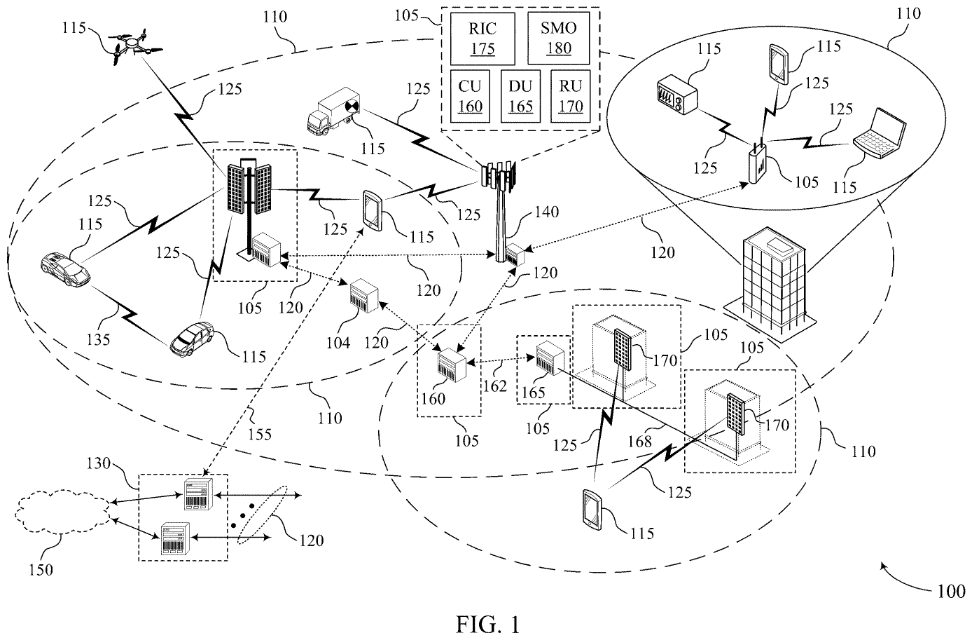

FIG. 1 shows an example of a wireless communications system 100 that supports dynamic monitoring of retransmission scheduling according to PDBs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support dynamic monitoring of retransmission scheduling according to PDBs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval. HARQ feedback may include an acknowledgment (ACK) or a negative acknowledgment (NACK) regarding the data associated with the feedback message (e.g., for one or more HARQ processes), where the ACK may indicate a successful decoding of information and NACK may indicate a failed attempt to decode the information. In some examples, incorrectly received data may be stored in a buffer and combined with subsequent transmissions to improve the overall likelihood of successfully decoding the data. In some cases, redundancy bits are added to each message prior to transmission. In other cases, redundancy bits are not added to each transmission, but are retransmitted after the transmitter of the original message receives a NACK indicating a failed attempt (e.g., based on a CRC error) to decode the information.

In some cases, a UE 115 may monitor a communication link 125 continuously for an indication that the UE 115 may receive data. In other cases (e.g., to conserve power and extend battery life) a UE 115 may be configured with a DRX cycle. A DRX cycle consists of an “On Duration” when the UE 115 may monitor for control information (e.g., on PDCCH) and a “DRX period” when the UE 115 may power down one or more radio components. In some cases, a UE 115 may be configured with a short DRX cycle and a long DRX cycle. In some examples, the UE 115 may enter a long DRX cycle if it is inactive for one or more short DRX cycles. The transition between the short DRX cycle, the long DRX cycle, and continuous reception may be controlled by one or more internal timers at the UE 115 or by messaging from a network entity 105, or both. A UE 115 may receive scheduling messages on PDCCH during the On Duration. While monitoring PDCCH for a scheduling message, the UE 115 may initiate a “DRX Inactivity Timer.” If a scheduling message is successfully received, the UE 115 may prepare to receive data and the DRX Inactivity Timer may be reset. When the DRX Inactivity Timer expires without receiving a scheduling message, the UE 115 may move into a short DRX cycle and may start a “DRX Short Cycle Timer.” When the DRX Short Cycle Timer expires, the UE 115 may resume a long DRX cycle.

In some examples of the wireless communications system 100, wireless devices (e.g., UEs 115 and network entities 105) may transmit and receive XR data packets. XR traffic in a wireless communications system (e.g., a 5G system) may include VR traffic, AR traffic, MR traffic, or any combination thereof, which may require high reliability and low latency transmissions. XR traffic may include different traffic flows for downlink data and uplink data. In some cases, some of the XR traffic flows may have relatively limited PDBs and wireless devices (e.g., UEs 115 and network entities 105) may have difficulty meeting latency requirements when there may be a fluctuation of network capability and, in some cases, the wireless devices may fail to decode the data from the traffic flow. As such, retransmissions may occur to aid in a wireless device successfully receiving and decoding a data packet of a given traffic flow.

When data packets may be retransmitted, wireless devices may stay awake during at least a retransmission timer waiting for a retransmission of the data packet or for retransmission scheduling. However, in cases with limited PDBs, there may be a relatively small amount of time, if any time, for a wireless device to receive or transmit the retransmitted data packet and the wireless device may waste power waiting for the timers to expire (e.g., waiting for the retransmitted data packet or retransmission scheduling information). Moreover, even if a wireless device receives a retransmission of a data packet, there may be a relatively small amount time allocated to combine the retransmission with the initial transmission and decode the data packet. Therefore, retransmissions may have a high probability of exceeding the PDB and may be unable to improve the transmission reliability and accuracy when XR traffic flows may have tight PDBs.

Wireless communications system 100 may support techniques for dynamically enabling a UE 115 (e.g., an XR device) to transition to (or remain in) a sleep state based on a PDB of a traffic flow. For example, when PDBs of a traffic flow may be relatively limited (e.g., a traffic flow has a short PDB, a PDB that is stringent) and retransmissions may be unobtainable, a network entity 105 may indicate to a UE 115 to go into a sleep state to save power at the UE 115, for example, rather than waiting for a retransmission that does not satisfy the PDB. For example, the network entity 105 may indicate to the UE 115 to enter the sleep state immediately after transmitting a feedback message associated with decoding a first downlink message (e.g., the feedback message indicates whether the UE 115 successfully decoded the first downlink message). In some aspects, when a retransmission may be possible (e.g., when processing the retransmission satisfies the PDB of the traffic flow), instead of having the UE 115 wait for the retransmission, the UE 115 may go to sleep after transmitting the feedback message and the network entity 105 may transmit a WUS for the UE 115 to wake up and receive the retransmission. As such, the UE 115 may receive the retransmission of the first downlink message while a retransmission timer remains active and there is time left in the PDB.

In some cases, the UE 115 may indicate, after or while transmitting uplink data to the network entity 105, that the UE 115 may transition to the sleep state after transmitting the uplink data based on an amount of time left in the PDB that would allow for the network entity to schedule a retransmission and for the UE 115 to transmit the retransmission. That is, the UE 115 may determine that there is not enough time to receive scheduling information and transmit the retransmission of the uplink message, and the UE 115 may transition to the sleep state after an initial uplink transmission. Additionally, or alternatively, the WUS may be repurposed to indicate that the UE 115 should go to sleep. For example, the network entity 105 may transmit the WUS to the UE 115 (e.g., a UE 115 in an awake state) in cases where the network entity 105 has to cancel a retransmission. As such, the techniques of the present disclosure may enable having the UE 115 go to sleep during a retransmission timer. Similarly, the described techniques may enable the UE 115 to refrain from waiting for retransmissions during these retransmission time, unless indicated to wake up and monitor for signaling scheduling the retransmission (or wake up to transmit or receive the retransmission). Such techniques may save power at the UE 115 when retransmissions may exceed a PDB compared to traditional techniques, where the UE 115 may stay awake regardless of whether a PDB of an XR traffic flow can afford a retransmission.

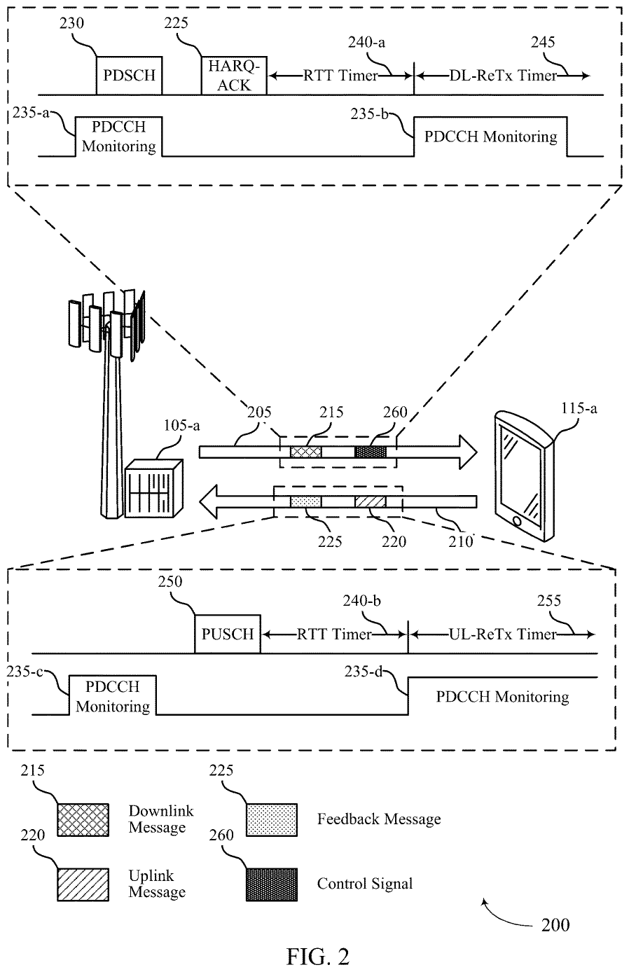

FIG. 2 shows an example of a wireless communications system 200 that supports dynamic monitoring of retransmission scheduling according to PDBs in accordance with one or more aspects of the present disclosure. In some examples, the wireless communications system 200 may implement or be implemented by the wireless communications system 100. For example, the wireless communications system 200 may include a UE 115-a and a network entity 105-a, which may represent examples of corresponding devices described herein. The UE 115-a and the network entity 105-a may communicate via a downlink communication link 205 and an uplink communication link 210, which may be examples of a communication link 125 described with reference to FIG. 1. The downlink communication link 205 and/or the uplink communication link 210 may be examples of a Uu link, a sidelink, a backhaul link, a D2D link, or some other type of communication link 125 described herein with reference to FIG. 1.

In some examples of the wireless communications system 200, the UE 115-a and/or the network entity 105-a may be examples of XR devices and may share XR-related data via the downlink communication link 205 and the uplink communication link 210. For example, the network entity 105-a may transmit a downlink message 215 to the UE 115-a and the UE 115-a may transmit an uplink message 220 to the network entity 105-a, where the downlink message 215 and the uplink message 220 may include XR data or be an example of XR data transmissions.

In some cases, the XR data may be transmitted and received by the UE 115-a and the network entity 105-a based on different traffic flows. For example, there may be respective traffic flows for uplink communications (e.g., XR data transmitted from the UE 115-a to the network entity 105-a) and downlink communications (e.g., XR data transmitted from the network entity 105-a to the UE 115-a). The traffic flows may be multi-modal and may have some quality of service (QoS) parameters (e.g., reliability, latency, and data rate). In some cases, a latency requirement of a transmission may be relatively smaller than an RTT of an end-to-end transmission PDB. Additionally, or alternatively, some traffic flows may have relatively small latency and reliability requirements. For example, Table 1 shows examples of different traffic flows and corresponding parameters for XR communications.

TABLE 1

| | | Bit | | | Average | |
|---|---|---|---|---|---|---|
| | | Rate | Frequency | Period | Payload | Air-link |
| Flow | Description | (Mbps) | (Hz) | (ms) | (kbits) | PCB (ms) |
| A | DL Video | 10.000 | 48 | 20.83 | 208.33 | 7 |
| H | DL Audio | 0.094 | 48 | 20.83 | 1.95 | 15 |
| B | UL Head Pose | 0.094 | 96 | 10.42 | 0.98 | 1 |
| C1 | UL Hand Tracking | 0.491 | 23 | 43.48 | 21.35 | 10 |
| F | UL Face Camera | 0.038 | 15 | 66.67 | 2.53 | 67 |
| | Frames (for | | | | | |
| | Stats/Feature Points) | | | | | |
| E | UL Camera Frames | 2.133 | 5 | 200.00 | 426.00 | 100 |
| | (for 3D | | | | | |
| | Reconstruction for | | | | | |
| | Object Recognition) | | | | | |
| G | UL Audio | 0.094 | 48 | 20.83 | 1.95 | 15 |

As illustrated in Table 1, the downlink traffic flows may include flow A and H and the uplink traffic flows may include flows B, C1, F, F, and/or G. In some cases, traffic flows A, B and C1 may have relatively limited PDBs, whereas traffic flows F and F may require low latency but may have relatively high payload sizes and may be associated with a relatively large bandwidth to carry such traffic flow. In such traffic flows, low latency, high reliability, and high data rates may be critical features of the XR-related traffic and communications. Such features, however, may challenge the network capabilities of the wireless communications system 200.

For example, for some traffic flows (e.g., traffic flows A, H, B, C1, and G) with relatively stringent PDBs (e.g., PDBs having short durations), wireless devices (e.g., the UE 115-a and the network entity 105-a) may have difficulties meeting the latencies requirements when there may be a fluctuation of the network capability. As such, there may be a relatively high probability that retransmissions may exceed the corresponding PDB, as the time remaining in the PDB may be limited, and the wireless devices may be unable to merge the retransmission and initial transmission when the initial transmission decoding fails. For example, the UE 115-a may receive the downlink message 215 via the downlink communication link 205 from the network entity 105-a, and the UE 115-a may fail to decode the downlink message 215. As such, the network entity 105-a may transmit a retransmission of the downlink message 215 to the UE 115-a. However, due to the PDB of the traffic flow for the downlink message 215, the UE 115-a may be unable to merge the initial transmission of the downlink message 215 with the retransmission of the downlink message 215 within a time that satisfies the PDB. As such, retransmissions may be unable to improve the transmission reliability for some traffic flows with a stringent PDB.

In some examples, to improve reliability of XR-related traffic, wireless devices may use FEC by adding additional bits for enhancing the probability of a successful transmission (e.g., successful decoding). In some cases, using FEC may replace the retransmission HARQ mechanism to provide reliability for some XR traffic flows having relatively short PDBs. In such cases, however, the additional bits may increase overhead.

The UE 115-a may operate using DRX (e.g., CDRX, Idle DRX), which may provide a mechanism by which the UE 115-a saves power when the UE 115-a is not actively communicating with the network entity 105-a. For example, using DRX, the UE 115-a may refrain from being continuously awake (e.g., in an awake state) to monitor for, receive, and decode downlink data. Likewise, the UE 115-a may refrain from being continuously awake when the UE 115-a does not have uplink data to transmit. In some aspects, multiple timers (e.g., drx-onDurationTimer, drx-InactivityTimer, drx-HARQ-RTT-TimerDL, drx-HARQ-RTT-TimerUL, drx-RetransmissionTimerDL, drx-RetransmissionTimerUL, among other examples) may be used by the UE 115-a to determine when, and for how long, the UE 115-a may be awake or asleep. One or more parameters for DRX, including the respective timers, may be configured, for example, via control signaling (e.g., RRC signaling) receive by the UE 115-a from the network entity 105-a.

DRX may enable retransmissions (e.g., HARQ retransmissions) of data (e.g., uplink data, downlink data), while also enabling the UE 115-a to operate in a sleep state. As an example, when receiving an initial transmission of the downlink message 215 via a physical downlink shared channel (PDSCH), the UE 115-a may monitor for a control message scheduling the downlink message 215 during a physical downlink control channel (PDCCH) monitoring period 235-a. The downlink message 215 may be referred to as, and correspond to, a PDSCH message 230, and the PDSCH message 230 may accordingly include downlink XR data and may be associated with a traffic flow (e.g., traffic flows A or H depicted in Table 1). After the transmission of the PDSCH message 230, the UE 115-a may attempt to decode the PDSCH message 230 using one or more decoders at the UE 115-a. In some cases, the UE 115-a may successfully decode the PDSCH message 230 and transmit a feedback message 225 (e.g., a HARQ message, a HARQ-ACK message) that indicates, to the network entity 105-a via the uplink communication link 210, a successful reception and decoding of the PDSCH message 230. After the UE 115-a transmits the feedback message 225, the UE 115-a may switch a main receiver of the UE 115-a to a sleep state based on a DRX cycle.

In some other cases, the UE 115-a may be unable to decode the PDSCH message 230, and the feedback message 225 may accordingly indicate an unsuccessful decoding (e.g., indicating a NACK) of the PDSCH message 230 to the network entity 105-a via the uplink communication link 210. When the UE 115-a transmits NACK via the feedback message 225, the UE 115-a may start an RTT timer 240-a (e.g., drx-HARQ-RTT-TimerDL, which may be equivalent to a set (e.g., configured) amount of time (e.g., a quantity of symbols) before a HARQ retransmission may be received. That is, the RTT timer 240-a may correspond to a per-HARQ process minimum duration before a downlink assignment for the HARQ retransmission of the PDSCH message 230 is expected by the UE 115-a (e.g., by a MAC entity of the UE 115-a). After the RTT timer 240-a expires, the UE 115-a may start a downlink retransmission timer 245 (e.g., a drx-RetransmissionTimerDL) to monitor for control signaling (e.g., DCI via PDCCH) scheduling a retransmission of the downlink message 215 (e.g., the PDSCH message 230). As such, the UE 115-a may monitor for a retransmission of the PDSCH message 230 during a PDCCH monitoring period 235-b while the downlink retransmission timer 245 is running (e.g., remains active).

However, as described herein, in some cases, based on a PDB of the traffic flow associated with the downlink message 215, there may not be enough time in the PDB of the traffic flow for the UE 115-a to receive the retransmission and/or combine the retransmission with the initial transmission of the downlink message 215. In such cases, the UE 115-a may remain awake during the downlink retransmission timer 245, which may consume excess power at the UE 115-a, thereby affecting the battery life of the UE 115-a (e.g., an XR device that may be power constrained). As an illustrative example, the downlink message 215 may include an XR data packet from the traffic flow A and may have a PDB of 7 ms. In some cases, the PDB of the traffic flow A may be equal to, smaller than, or relatively similar to the RTT of the feedback message 225. For instance, the RTT may be 56 symbols (e.g., 56 OFDM symbols, which may be equal to about 3.75 ms with a 15 kHz subcarrier spacing), thus, at least about 3.75 ms may pass before the UE 115-a expects to receive PDCCH message that schedules the retransmission. As such, there may be only about 3.25 ms left in the PDB associated with the traffic flow for the UE 115-a to identify the resource allocation for the retransmission as indicated by a scheduling DCI and receive and decode the retransmission. In such cases, the UE 115-a may be unable to receive the retransmission within a time that satisfies the PDB. In other examples, even if the UE 115-a does receive the retransmission of the downlink message 215, the UE 115-a may be unable to combine the retransmission with the initial transmission of the downlink message 215 (e.g., stored in a buffer) in a time that satisfies the PDB. As a result, the UE 115-a may have unnecessarily remained awake during the PDCCH monitoring period 235-b (e.g., based on the downlink retransmission timer 245, as the PDB could not be satisfied for the downlink message 215 associated with the traffic flow. While the values provided above are exemplary, it should be apparent that other values of the PDB and the RTT timer may be possible, which may similarly result in a retransmission that is not received and decoded within a time that satisfies the PDB of a traffic flow.

For uplink transmissions, DRX may similarly enable the UE 115-a to send retransmissions of one or more uplink messages, while providing for periods of sleep to conserve power of the UE 115-a. As an example, the UE 115-a may transmit the uplink message 220 to the network entity 105-a, where the uplink message 220 may be associated with a traffic flow (e.g., traffic flow B, C1, F, E, or G, as shown in Table 1). In some cases, the UE 115-a may monitor for a control message from the network entity 105-a during a PDCCH monitoring period 235-c for scheduling information for the uplink message 220, which may be referred to as, and correspond to, a physical uplink shared channel (PUSCH) message 250. The network entity 105-a may receive the PUSCH message 250 from the UE 115-a and attempt to decode the PUSCH message 250.

After transmitting the PUSCH message 250, the UE 115-a may start a RTT timer 240-b before starting an uplink retransmission timer 255 (e.g., a drx-RetransmissionTimer UL). The RTT timer 240-b may correspond to a per-HARQ process minimum duration before an uplink HARQ retransmission grant is expected by the UE 115-a (e.g., by a MAC entity of the UE 115-a). In some cases, the network entity 105-a may transmit a feedback message indicating whether the network entity 105-a successfully decoded the PUSCH message 250 or the network entity 105-a may indicate feedback based on transmitting the scheduling information. For example, the network entity 105-a may transmit a PDCCH message including DCI scheduling a retransmission of the uplink message 220 (e.g., the PUSCH message 250) when the network entity 105-a unsuccessfully decodes the uplink message 220, where the PDCCH message including the scheduling information may indicate the unsuccessful decoding of the PUSCH message 250.

As a result, while the uplink retransmission timer 255 is running (e.g., is active), the UE 115-a may monitor for the PDCCH message scheduling the retransmission of the uplink message 220 during a PDCCH monitoring period 235-d. After receiving the PDCCH message scheduling the retransmission of the uplink message 220, the UE 115-a may transmit the retransmission of the uplink message 220 to the network entity 105-a in accordance with the scheduling information received from the network entity 105-a.

In some cases, however, the PDB may be too limited or short to allow for retransmissions of the uplink message 220. As an illustrative example, the UE 115-a may transmit an uplink message 220 associated with traffic flow C1, which has a PDB of 10 ms, as shown in Table 1. Based on an example RTT timer duration of 56 symbols (e.g., OFDM symbols, which may be equal to about 3.75 ms for a 15 kHz subcarrier spacing), there may not be enough time to complete the retransmission of the uplink message 220. In particular, there may be less than about 6.25 ms left in the PDB for the UE 115-a to identify the resource assignment for the retransmission, transmit the retransmission to the network entity 105-a, and for the network entity 105-a to receive and decode (and possibly combine) the retransmission of the uplink message 220. Thus, in some cases (e.g., for some PDB values, for some RTT timer durations, or the like), the retransmission of the uplink message 220 (e.g., the PUSCH message 250) may not be completed in a time that satisfies the PDB of a traffic flow, resulting in the UE 115-a unnecessarily remaining awake during the PDCCH monitoring period 235-d, thereby causing excess power consumption.

Thus, in both the downlink and uplink scenarios for retransmissions associated with DRX, the RTT timers (e.g., the RTT timer 240-a and the RTT timer 240-b) and the retransmission timers (e.g., the downlink retransmission timer 245 and the uplink retransmission timer 255) may be unable to provide any sort of gain for XR data transmissions, particularly in cases where the PDB may be relatively small. Further, the aforementioned techniques may not rely on HARQ for transmission reliability, which may be important for XR data transmissions. As such, having the UE 115-a perform PDCCH monitoring for a retransmission or for scheduling information may be ineffective in cases where a PDB is restrictive, causing increased power consumption at the UE 115-a, which may be detrimental to the battery life of UEs 115 (e.g., an XR device having a limited battery size and capacity).

Therefore, in accordance with techniques described herein, the UE 115-a may remain in a sleep state in cases where a retransmission may not be processed or completed in an amount of time that satisfies a PDB of a traffic flow (e.g., an XR traffic flow or another type of traffic flow), thereby reducing power consumption at the UE 115-a. For example, the UE 115-a may determine, or the network entity 105-a may indicate to the UE 115-a via control signaling 260, whether the UE 115-a should start a retransmission timer (e.g., the downlink retransmission timer 245 and/or the uplink retransmission timer 255) based on an amount of time remaining in a PDB. For example, in cases where there may not be enough time remaining in the PDB of the traffic flow to receive a retransmission, decode the retransmission successfully, and/or combine the retransmission with the initial transmission, the UE 115-a may refrain from starting the retransmission timer (e.g., the UE 115-a may remain in a sleep state). As such, the UE 115-a may switch a main receiver of the UE 115-a to a sleep state, for example, following either transmitting the feedback message 225 indicating whether the downlink message 215 was successfully decoded or following transmitting the uplink message 220.

In some aspects, when switching the main receiver of the UE 115-a to the sleep state, a low-power (LP) wake-up receiver (LP-WUR) of the UE 115-a may remain awake. The LP-WUR of the UE 115-a may consume relatively less power compared to the main receiver of the UE 115-a. In some cases, the LP-WUR may be referred to as a WUR elsewhere herein. The main receiver of the UE 115-a may be used to receive wireless signals and may stay asleep until triggered by the reception of a WUS. As such, in cases when the main receiver of the UE 115-a (or one or more radio chains and/or other radio frequency (RF) components of the UE 115-a) may be in the sleep state (e.g., powered down), the WUR may monitor for WUSs to trigger the main receiver of the UE 115-a to wake-up (e.g., enter an awake state) or trigger the main receiver to complete a specific action (e.g., monitor for a message scheduling a retransmission). In some examples described herein, the WUS may also be used to cancel a retransmission, thereby enabling the UE 115-a to switch to a sleep state and conserve power.

In some examples, when the UE 115-a may be able to transmit the retransmission of the uplink message 220 or receive the retransmission of the downlink message 215 in accordance with the PDB of a traffic flow, the UE 115-a may instead perform measurements in a measurement gap. As such, when the UE 115-a conducts measurements in the measurement gap, any retransmissions may be unable to proceed. In such cases, the network entity 105-a may transmit an indication message, via a WUS or a DCI message, to the UE 115-a to cancel one or more possible retransmissions (e.g., the measurements may be prioritized over a retransmission). After the WUR or the main receiver of the UE 115-a receives the indication, the UE 115-a may refrain from attempting to blind decode any retransmission or retransmission scheduling message, which may save power at the UE 115-a. In some examples, the UE 115-a may autonomously determine whether to conduct measurements in a measurement gap. The UE 115-a may transmit the decision to the network entity 105-a via an uplink control information (UCI) message or a MAC-control element (MAC-CE), which may be transmitted via (e.g., piggybacked with) a PUSCH.

In cases when the UE 115-a determines to perform measurements, the network entity 105-a may notify the UE 115-a, for example, via a WUS or a DCI, to cancel all possible retransmissions (uplink and/or downlink). Following the UE 115-a transmitting the indication to the network entity 105-a indicating that the UE 115-a will perform the measurements, the UE 115-a may switch the main receiver of the UE 115-a to the sleep state, or the UE 115-a may prepare to perform measurements in the measurement gap. Further, the UE 115-a may be configured, via a RRC message, with multiple measurement gap patterns and the network entity 105-a may indicate the UE 115-a, via a WUS or DCI message, to select a measurement pattern (e.g., a staggering measurement pattern) that enables retransmissions to enhance the reliability of the XR data transmissions of a traffic flow. In cases, where the UE 115-a determines to receive the retransmission instead of performing measurements, the network entity 105-a may transmit the downlink message 215 scheduling a retransmission, as discussed previously herein.

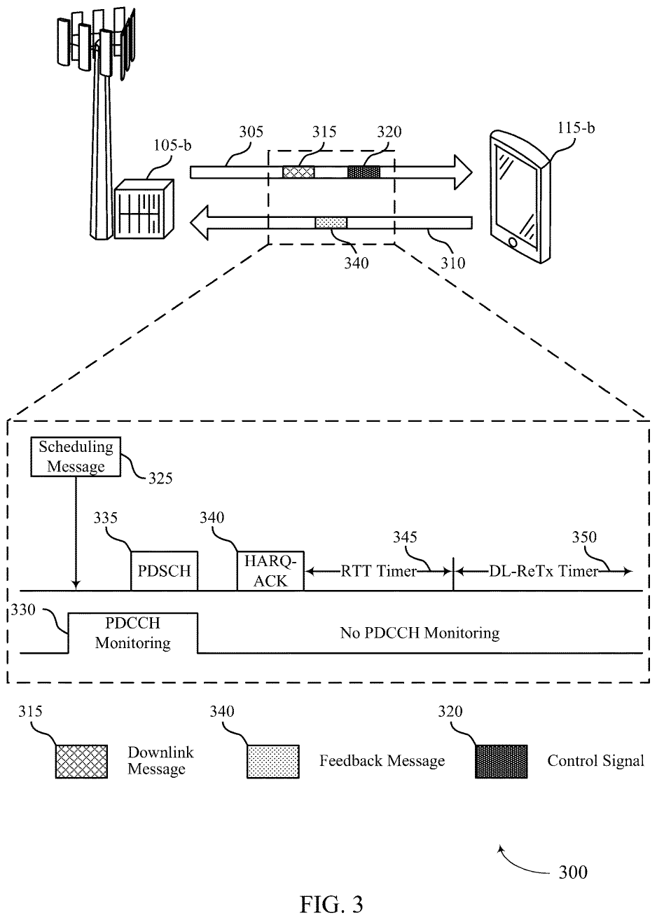

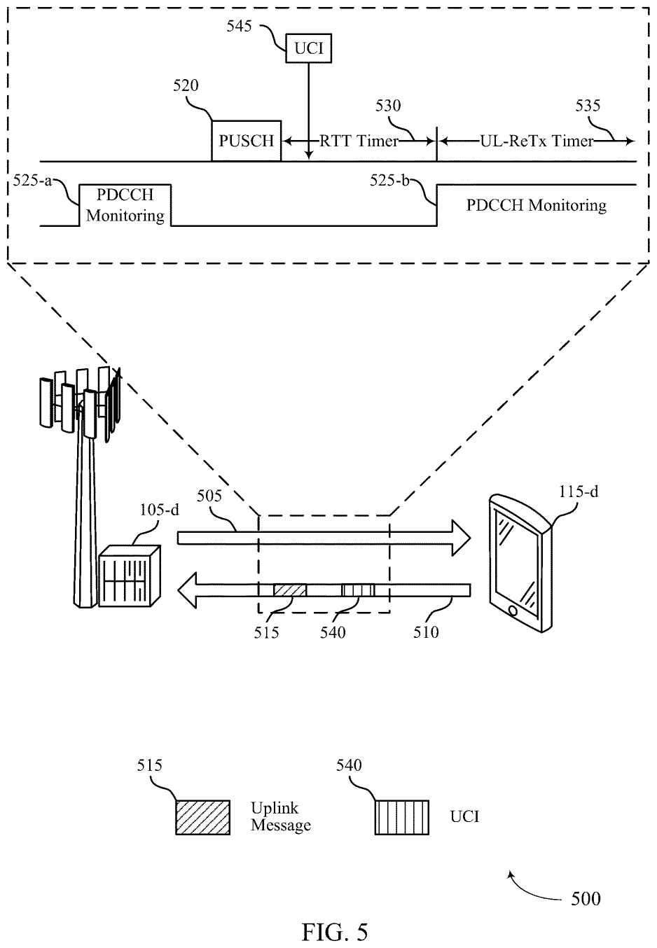

Thus, as described herein, the techniques of the present disclosure may provide power savings at the UE 115-a and may enable dynamic use of the DRX timers for XR-related traffic having relatively small PDBs by supporting dynamic monitoring for retransmission scheduling according to the PDB of a traffic glow. For example, as described with reference to FIGS. 3, 4, and 7 the UE 115-a may go to sleep after failing to decode the downlink message 215, and the UE may remain asleep until the network entity 105-a schedules a retransmission if the PDB is too small for a retransmission. Similarly, as described with reference to FIGS. 5, 6, and 8 the UE 115-a may go to sleep after transmitting an uplink message 220 to the network entity 105-a until an indication from the network entity 105-a scheduling a retransmission or until the UE 115-a transmits the next uplink message 220. As such, having the UE 115-a switch to (and/or remain in) the sleep state may enhance the communications of XR data as the UEs 115 may have increased power savings, which may allow for more efficient, accurate, and reliable communications in the wireless communications system 200.

FIG. 3 shows an example of a wireless communications system 300 that supports dynamic monitoring of retransmission scheduling according to PDBs in accordance with one or more aspects of the present disclosure. In some examples, the wireless communications system 300 may implement or be implemented by the wireless communications system 100 or the wireless communications system 200. For example, the wireless communications system 300 may include a UE 115-b and a network entity 105-b, which may represent examples of corresponding devices described herein. The UE 115-b and the network entity 105-b may communicate via a downlink communication link 305 and an uplink communication link 310, which may be examples of a communication link 125 described with reference to FIG. 1. The downlink communication link 305 and/or the uplink communication link 310 may be examples of a Uu link, a sidelink, a backhaul link, a D2D link, or some other type of communication link 125 described herein with reference to FIG. 1.

In some examples of the wireless communications system 300, the UE 115-b may receive a downlink message 315 via the downlink communication link 305. The downlink message 315 may be a downlink data transmission that includes downlink video or audio. Further, the UE 115-b may monitor for a scheduling message 325 that schedules the downlink message 315 during a PDCCH monitoring period 330. In some examples, the scheduling message 325 may be a DCI message and the downlink message 315 may be a PDSCH message 335. After receiving the PDSCH message 335, the UE 115-b may transmit a feedback message 340 (e.g., a HARQ message) indicating whether the UE 115-b successfully decoded the PDSCH message 335. In some cases, if the UE 115-b successfully decodes the PDSCH message 335, the UE 115-b may switch to a sleep state in accordance with a DRX cycle. In some other cases, such as when the UE 115-b unsuccessfully decodes the PDSCH message 335, the UE 115-b may transmit an indication that the PDSCH message 335 was unsuccessfully decoded.

Based on the PDB of the traffic flow for the downlink message 315, having the UE 115-b start the downlink retransmission timer 350 when a retransmission may be infeasible (e.g., when the UE 115-b may be unable to decode the retransmission of the downlink message 315 in a time that satisfies the PDB). As such, having the UE 115-b start the downlink retransmission timer 350 may cause unnecessary power consumption at the UE 115-b. Therefore, the network entity 105-a may transmit a control signal 320 to the UE 115-b indicating whether the UE 115-b should enter the downlink retransmission timer 350 according to the PDB of the traffic flow for the downlink message 315. For example, the PDB for at least some traffic flows may be relatively small and there may not be much time left after the initial transmission of the downlink message 315, the transmission of the feedback message 340, and/or subsequent transmission and decoding of the retransmission. As such, the network entity 105-b may indicate to the UE 115-b, via the control signal 320, that the UE 115-b is to refrain from entering the RTT timer 345 and/or the downlink retransmission timer 350 for monitoring for retransmission scheduling. That is, the network entity 105-b may provide signaling indicating that the UE 115-b may transition to a sleep state after transmitting the feedback message 340. In some cases, the control signal 320 may be signaled via the scheduling message 325 (e.g., a DCI scheduling message) that scheduled the initial transmission of the downlink message 315 or via a another, separate message. As such, after the UE 115-b receives the scheduling message 325, the UE 115-b may determine or identify that, after transmitting the feedback message 340, the UE 115-b may transition to the sleep state for the duration of the RTT timer 345 and the downlink retransmission timer 350.

In some other cases, the control signal 320 indication may be indicated to the UE 115-b via a single bit indicator that may transmitted along with (e.g., piggybacked with) the downlink message 315 (e.g., the PDSCH message 335). As such, the PDSCH message 335 including the downlink XR data may include one or more additional bits to indicate whether the UE 115-b should enter the RTT timer 345 and the downlink retransmission timer 350. For example, if the extra bit equals 1, the UE 115-b may determine to enter the RTT timer 345 and the downlink retransmission timer 350 and if the extra bit equals 0, the UE 115-b may refrain from entering the RTT timer 345 and the downlink retransmission timer 350, or vice versa. Therefore, after the UE 115-b receives the PDSCH message 335 with the control signal 320 piggybacked, the UE 115-b may determine whether to enter the RTT timer 345 and the downlink retransmission timer 350 after transmitting the feedback message 340 and whether to transition to the sleep state.

When transitioning to the sleep state, the UE 115-b may switch a receiver of the UE 115-b to the sleep state. For example, the UE 115-b may switch the main receiver of the UE 115-b from an awake state to the sleep state. As such, while in the sleep state (e.g., when asleep), the main receiver of the UE 115-b may be unable to receive signaling from other wireless devices (e.g., the network entity 105-b). As the main receiver of the UE 115-b may consume a relatively large amount of power, transitioning the main receiver of the UE 115-b to a sleep state may result in relatively high levels of power savings at the UE 115-b (e.g., compared to the UE 115-b being active and awake for monitoring PDCCH during a retransmission timer). As such, the UE 115-b may switch to the sleep state instead of monitoring for a retransmission of the downlink message 315 that the UE 115-b may be unable to successfully decode due to a short PDB of the traffic flow for the downlink message 315.

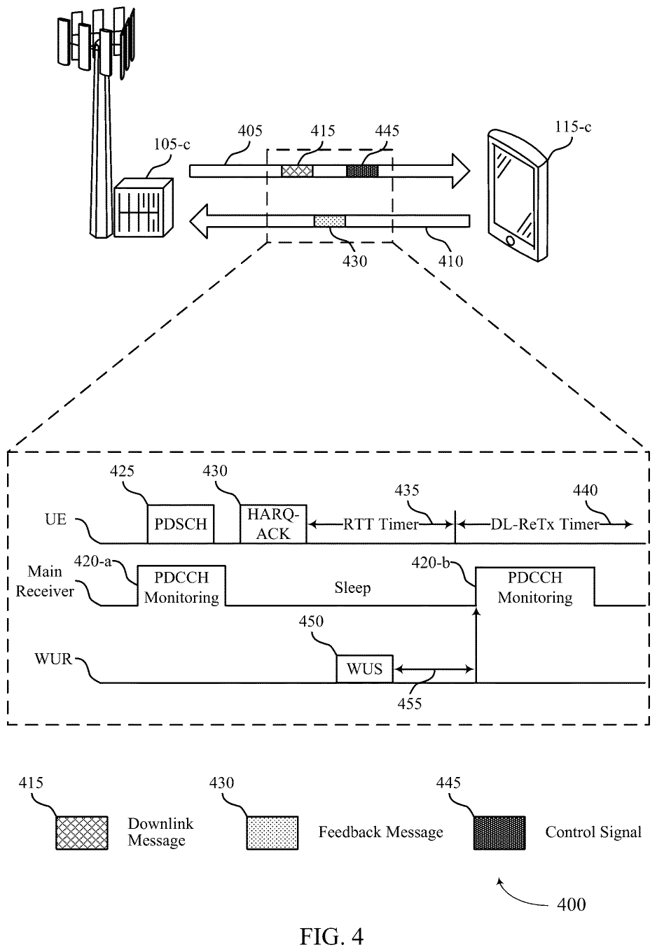

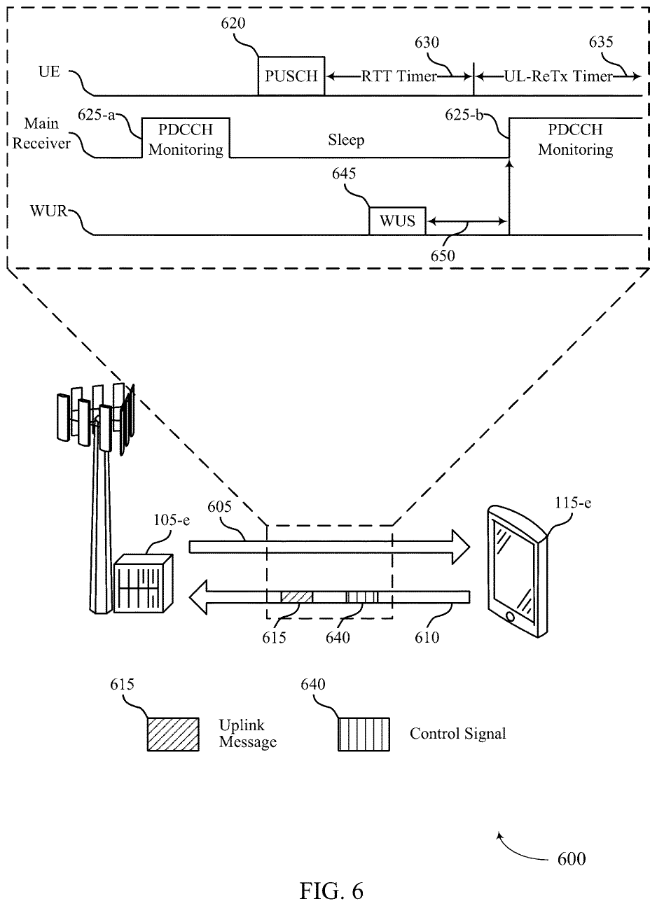

In some examples, a WUR of the UE 115-b may remain awake when the main receiver of the UE 115-b is asleep and may monitor for a WUS indicating that the UE 115-b should wake-up (e.g., the main receiver should transition from the sleep state to an awake state). In some cases, if the PDB of a traffic flow has enough time for the UE 115-b to receive a retransmission of the downlink message 315 and attempt to decode the downlink message 315, the network entity 105-b may transmit a WUS for the UE 115-b to transition to an awake state to receive the retransmission of the downlink message 315. Additional descriptions of such techniques of a UE 115-b in the sleep state receiving a WUS and monitoring for the retransmission of the downlink message 315 are described with reference to FIG. 4. Descriptions of techniques of a UE 115-b transmitting uplink messages and transitioning to the sleep state afterwards are described with reference to FIGS. 5 and 6.

FIG. 4 shows an example of a wireless communications system 400 that supports dynamic monitoring of retransmission scheduling according to PDBs in accordance with one or more aspects of the present disclosure. In some examples, the wireless communications system 400 may implement or be implemented by the wireless communications system 100, the wireless communications system 200, or the wireless communications system 300. For example, the wireless communications system 400 may include a UE 115-c and a network entity 105-c, which may represent examples of corresponding devices described herein. The UE 115-c and the network entity 105-c may communicate via a downlink communication link 405 and an uplink communication link 410, which may be examples of a communication link 125 described with reference to FIG. 1. The downlink communication link 405 and/or the uplink communication link 410 may be examples of a Uu link, a sidelink, a backhaul link, a D2D link, or some other type of communication link 125 described herein with reference to FIG. 1.

In some examples of the wireless communications system 400, the UE 115-c may receive a downlink message 415 via the downlink communication link 405. The downlink message 415 may be a downlink XR data transmission that includes downlink XR video or audio. Further, the UE 115-c may monitor for a scheduling message that schedules the downlink message 415 during a PDCCH monitoring period 420-a. In some examples, the scheduling message may be a DCI message and the downlink message 415 may be a PDSCH message 425. After receiving the PDSCH message 425, the UE 115-c may transmit a feedback message 430 (e.g., a HARQ message) indicating whether the UE 115-c successfully decoded the PDSCH message 425. In some cases, if the UE 115-c successfully decodes the PDSCH message 425, the UE 115-c may switch to a sleep state in accordance with a DRX cycle. In some other cases, such as when the UE 115-c unsuccessfully decodes the PDSCH message 425, the UE 115-b may transmit an indication that the PDSCH message 425 was unsuccessfully decoded.

Based on a control signal 445 indicating that the UE 115-c is to transition to the sleep state after the feedback message 430 is transmitted, after the UE 115-c transmits the feedback message 430, the UE 115-c may enter the sleep state in which a main receiver of the UE 115-c may be asleep (e.g., powered down) and a WUR may remain active, as described herein with reference to FIGS. 2 and 3. In some examples, the control signal 445 may configure the UE 115-c to switch a receiver of the UE 115-c (e.g., the main receiver of the UE 115-c) to the sleep state (e.g., when the feedback message 430 indicates that the downlink message 415 was unsuccessfully decoded, when the feedback message 430 indicates that the downlink message 415 was successfully decoded). In some cases, the control signal 445 may be an RRC or MAC-CE message. Further, the network entity 105-c may transmit the control signal 445 to the UE 115-c prior to the UE 115-c transmitting the feedback message 430.

In some examples, while the main receiver of the UE 115-c may be in the sleep state, the WUR may receive one or more WUSs 450. For example, the network entity 105-c may know the PDB of each XR traffic flow (e.g., as illustrated in Table 1), and the network entity 105-c may thus know or be able to calculate a remaining time for a retransmission of the downlink transmission after the initial transmission of the downlink message 415. As such, the network entity 105-c may determine, based on the PDB of the traffic flow for the downlink message 415 (as well as a duration of the RTT timer 435), that there may be enough time for a retransmission of the downlink message 415. Thus, to enhance the reliability of the wireless communications system 400, the network entity 105-c may transmit the WUS 450 to wake up the UE 115-c for a retransmission of the downlink message 415. As such, the network entity 105-c may transmit the WUS 450 to the WUR of the UE 115-c indicating that the UE 115-c switch the receiver of the UE 115-c (e.g., the main receiver of the UE 115-c) to an awake state to monitor for a control message (e.g., a PDCCH message) scheduling the retransmission of the downlink message 415. Here, the transmission of the WUS 450 is based on a processing time for the retransmission of the downlink message 415 satisfying the PDB of the traffic flow for the downlink message 415. As such, the WUS 450 may indicate that the UE 115-c is to monitor for the retransmission of the downlink message 415 based on the control message (e.g., the PDCCH message) scheduling the retransmission of the downlink message 415.

The UE 115-c may switch the receiver of the UE 115-c (e.g., the main receiver of the UE 115-c) to the awake state in response to the WUS 450. After switching the main receiver of the UE 115-c to the awake state, the UE 115-c may monitor for and receive the control message scheduling the retransmission of the downlink message 415. In some aspects, after receiving the WUS 450, the UE 115-c may start a downlink retransmission timer 440. In some cases, the PDCCH monitoring period 420-b may correspond to at least a portion of the downlink retransmission timer 440, and the UE 115-c may monitor for the control message while the downlink retransmission timer 440 remains active during the PDCCH monitoring period 420-b. The network entity 105-c may transmit, to the UE 115-c, the retransmission of the downlink message 415 based on the main receiver of the UE 115-c being in an awake state. Moreover, the UE 115-c may receive the retransmission of the downlink message 415 in accordance with the control signal 445 scheduling the retransmission of the downlink message 415.

In some cases, the UE 115-c may switch the receiver of the UE 115-c (e.g., the main receiver of the UE 115-c) to the awake state after an interval of time 455 starting after the WUS 450 is received. For example, the WUR of the UE 115-c may wait for the interval of time 455 before sending a signal to the main receiver of the UE 115-c to transition from the sleep state to the awake state. In some cases, the signal from the WUR to the main receiver of the UE 115-c may be a presence of energy. As such, the WUR may transmit energy to the main receiver of the UE 115-c and the main receiver of the UE 115-c may wake-up and switch from the sleep state to the awake state and may begin to monitoring for scheduling information and parameters in the PDCCH monitoring period 420-b for receiving the transmission of the downlink message 415. Thus, in some cases, the UE 115-c may begin to perform PDCCH monitoring some amount of time after the downlink retransmission timer 440 is started (e.g., based on the timing of the WUS 450, based on capabilities of the UE 115-c to transition to the awake state, or the like).

In some other examples, the WUS 450 may indicate for the UE 115-c to switch the receiver of the UE 115-c to the awake state, and the WUS 450 may further indicate scheduling parameters for receiving the retransmission of the downlink message 415. Therefore, the WUR may be used to receive the scheduling parameters for receiving the retransmission of the downlink message 415 (e.g., instead of having the main receiver blind decode for a PDCCH message scheduling the retransmission of the downlink message 415). For example, as described herein, after transmitting the feedback message 430, the main receiver UE 115-c may go to sleep and refrain from acknowledging the RTT timer 435 and the downlink retransmission timer 440 while the WUR remains active.

The network entity 105-c may determine or identify that the PDB of the traffic flow for the downlink message 415 may be able to support a retransmission of the downlink message 415. Additionally, or alternatively, the network entity 105-c may determine or identify that there may be enough time left in the PDB for the UE 115-c to receive and merge the retransmission of the downlink message 415 with the initial transmission of the downlink message 415. As such, the network entity 105-c may transmit the WUS 450 to the WUR of the UE 115-c, and the UE 115-c may receive the WUS 450 that indicates the scheduling parameters for the retransmission of the downlink message 415. As an example, the scheduling parameters carried by the WUS 450 may include an indication of time/frequency resources (or other parameters that would otherwise be carried by some scheduling messages, such as DCI) associated with the retransmission of the downlink message 415. As the UE 115-c may obtain the scheduling parameters for the retransmission of the downlink message 415, the UE 115-c may refrain from monitoring for a scheduling message (e.g., a scheduling DCI) during the PDCCH monitoring period 420-b. Therefore, the UE 115-c may refrain from blind decoding the scheduling message, which may increase power savings at the UE 115-c.

Further, after receiving the WUS 450 that includes the scheduling parameters, the UE 115-c may monitor for only the retransmission of the downlink message 415. While such techniques may result in additional information indicated by the WUS 450 (e.g., the scheduling parameters carried by with the WUS 450), such techniques may result in additional power savings, as the UE 115-c may monitor for the retransmission of the downlink message 415 alone, instead of monitoring for both the scheduling message and the retransmission.

In another example (not illustrated), the network entity 105-c may transmit a WUS 450 to indicate that the UE 115-c transition to the sleep state. For instance, after the UE 115-c transmits the feedback message 430, the UE 115-c may remain in the awake state (e.g., the main receiver of the UE 115-c may remain awake), start the downlink retransmission timer 440, and remain active during the downlink retransmission timer 440 to monitor for a PDCCH transmission. However, prior to the UE 115-c starting the downlink retransmission timer 440 or while the downlink retransmission timer 440 is running, the network entity 105-c may determine or identify that a retransmission of the downlink message 415 may exceed the PDB. As such, the network entity 105-c may transmit the WUS 450 to the UE 115-c to cancel the retransmission, and the UE 115-c may accordingly switch the receiver of the UE 115-c (e.g., the main receiver) to the sleep state in response to the WUS 450 (e.g., based on the retransmission of the downlink message 415 exceeding the PDB). Thus, in response to receiving the WUS 450, the UE 115-c may transition to the sleep state regardless of whether the downlink retransmission timer 440 is active, which may result in power savings at the UE 115-c (e.g., by preventing the UE 115-c from remaining awake when a retransmission is unable to satisfy a PDB associated with a traffic flow).

Even though such technique may save relatively less power than other techniques described herein, using the WUS 450 to indicate that the UE 115-c is to go into the sleep state may save power compared to UE 115-c remaining in an awakes state for the entirety of the downlink retransmission timer 440. Therefore, the UE 115-c may use the WUR to receive indications (e.g., one or more WUSs 450) from the network entity 105-c to trigger the main receiver to wake-up or go to sleep according to the PDB of the traffic flow for the downlink message 415. While the UE 115-c may be in an awake state and monitor for the retransmission of the downlink message 415 according to the dynamic indication of the WUS 450, by having the UE 115-c remain asleep or in the sleep state for a portion of the downlink retransmission timer 440, the UE 115-c may save power therefore increasing the reliability of the wireless communications system 400.

FIG. 5 shows an example of a wireless communications system 500 that supports dynamic monitoring of retransmission scheduling according to PDBs in accordance with one or more aspects of the present disclosure. In some examples, the wireless communications system 500 may implement or be implemented by the wireless communications system 100, the wireless communications system 200, the wireless communications system 300, or the wireless communications system 400. For example, the wireless communications system 500 may include a UE 115-d and a network entity 105-d, which may represent examples of corresponding devices described herein. The UE 115-d and the network entity 105-d may communicate via a downlink communication link 505 and an uplink communication link 510, which may be examples of a communication link 125 described with reference to FIG. 1. The downlink communication link 505 and/or the uplink communication link 510 may be examples of a Uu link, a sidelink, a backhaul link, a D2D link, or some other type of communication link 125 described herein with reference to FIG. 1.

In some examples of the wireless communications system 500, the UE 115-d may transmit an uplink message 515 via the uplink communication link 510. The uplink message 515 may be an uplink XR data transmission which may be a PUSCH message 520 that includes uplink head pose, head tracking, face camera frames, or audio information for XR data. For example, an XR device (e.g., the UE 115-d) may use a camera for pose recognition and may transmit different information using different traffic flows. Further, prior to transmitting the uplink message 515, the UE 115-d may monitor for scheduling information during a PDCCH monitoring period 525-a. As such, after receiving the scheduling information, the UE 115-d may transmit the uplink message 515 from an uplink traffic flow (e.g., traffic flow B, C1, F, E, or G described with reference to Table 1) having a PDB.

After transmitting the uplink message 515, the UE 115-d may start an RTT timer 530. In some cases, the network entity 105-d may fail to decode the uplink message 515 and may determine whether to transmit a downlink message scheduling a retransmission of the uplink message 515 based on the PDB of the traffic flow for the uplink message 515. For example, if there is enough time remaining in the PDB, the network entity 105-d may transmit the downlink message scheduling the retransmission of the uplink message 515. In some other cases, there may not be enough time left in the PDB for the UE 115-d to both receive the downlink message scheduling the retransmission of the uplink message 515 and transmit the retransmission of the uplink message 515. Thus, based on the PDB of the traffic flow for the uplink message 515, having the UE 115-d start the uplink retransmission timer 535 and monitor for scheduling information for the retransmission of the uplink message 515 during a PDCCH monitoring period 525-b when a retransmission may be infeasible may cause unnecessary power consumption at the UE 115-d.

Therefore, the UE 115-d may transmit a control signal 540 to the network entity 105-d indicating whether the UE 115-d will start the uplink retransmission timer 535 according to the PDB of the traffic flow for the uplink message 515. For example, the PDB for certain traffic flows may be relatively small and there may not be much time remaining in the PDB after the initial transmission of the uplink message 515. As such, in cases where completing retransmissions may be infeasible, the UE 115-d may transmit the control signal 540, for example, via an UCI message 545, indicating that the UE 115-d may refrain from entering the uplink retransmission timer 535 based on the PDB of the traffic flow for the uplink message 515. Here, network entity 105-d may determine that scheduling the retransmission of the uplink message may be unnecessary based on the indication provided by the control signal 540. Further, the control signal 540 may indicate that the UE 115-d may switch a receiver of the UE 115-d (e.g., a main receiver) to a sleep state after transmitting the uplink message 515 based on the PDB of the traffic flow for the uplink message 515 and that a processing time for the retransmission of the uplink message 515 may exceed the PDB of the traffic flow for the uplink message 515. As such, the main receiver of the UE 115-d may remain in the sleep state until the uplink retransmission timer 535 expires. In some examples, the control signal 540 may be a one-bit indicator transmitted via the UCI message 545 and the UE 115-d may transmit the UCI message 545 after transmitting the uplink message 515. If the one-bit indicator equals 1, the UE 115-d may determine to enter the RTT timer 530 and the uplink retransmission timer 535 and if the one-bit indicator equals 0, the UE 115-d may refrain from entering the RTT timer 530 and the uplink retransmission timer 535, or vice versa. In some other cases, the UE 115-d may multiplex the UCI message 545 with the PUSCH message 520.

In some examples, the UE 115-d may transmit the control signal 540 via the UCI message 545 based on determining that there may not be enough time remaining in the PDB for a retransmission of the uplink message 515. For example, some uplink messages 515 may wait in a buffer for a relatively long period of time before the network entity 105-d may attempt to process and decode the uplink message 515. Thus, by the time the network entity 105-d attempts to decode the uplink message 515, the amount of time for a retransmission of the uplink message 515 may exceed the PDB of the traffic flow for the uplink message 515. For example, there may not be enough time left in the PDB for the network entity 105-d to schedule the retransmission of the uplink message 515, receive the retransmission, and merge the retransmission with the initial transmission of the uplink message 515. Therefore, for cases where there may not be enough time left in the PDB, or for cases where the PDB may be relatively small, or both, the UE 115-d may transmit the control signal 540 to indicate that the UE 115-d will refrain from entering the uplink retransmission timer 535 to save power at the UE 115-d and the UE 115-d may transition to the sleep state. While in the sleep state, a WUR of the UE 115-d may remain in an awake state and monitor for a WUS.

FIG. 6 shows an example of a wireless communications system 600 that supports dynamic monitoring of retransmission scheduling according to PDBs in accordance with one or more aspects of the present disclosure. In some examples, the wireless communications system 600 may implement or be implemented by the wireless communications system 100, the wireless communications system 200, the wireless communications system 300, the wireless communications system 400, or the wireless communications system 500. For example, the wireless communications system 600 may include a UE 115-e and a network entity 105-e, which may represent examples of corresponding devices described herein. The UE 115-e and the network entity 105-e may communicate via a downlink communication link 605 and an uplink communication link 610, which may be examples of a communication link 125 described with reference to FIG. 1. The downlink communication link 605 and/or the uplink communication link 610 may be examples of a Uu link, a sidelink, a backhaul link, a D2D link, or some other type of communication link 125 described herein with reference to FIG. 1.

In some examples of the wireless communications system 600, the UE 115-e may transmit an uplink message 615 via the uplink communication link 610. The uplink message 615 may be an uplink XR data transmission which may be a PUSCH message 620 that includes uplink head pose, head tracking, face camera frames, or audio information for XR data. For example, an XR device (e.g., the UE 115-e) may use a camera for pose recognition and may transmit different information using different traffic flows. Further, prior to transmitting the uplink message 615, the UE 115-e may monitor for scheduling information during a PDCCH monitoring period 625-a. As such, after receiving the scheduling information, the UE 115-e may transmit the uplink message 615 from an uplink traffic flow (e.g., a traffic flow B, C1, F, E, or G described with reference to Table 1) having a PDB.

In some examples, the UE 115-e may be configured by the network entity 105-e to go to sleep after transmitting the uplink message 615. For example, the network entity 105-e may transmit an RRC or MAC-CE message to the UE 115-e indicating that the main receiver of the UE 115-e is to transition to a sleep state after transmitting the uplink message 615. As such, the UE 115-e may refrain from starting an uplink retransmission timer 635 and go to sleep after transmitting the uplink message 615.

In cases where the network entity 105-e successfully decodes the uplink message 615, a retransmission may be unnecessary and having the UE 115-e awake during the uplink retransmission timer 635 may waste power at the UE 115-e. Additionally, or alternatively, the network entity 105-e may refrain from transmitting scheduling information for a retransmission of the uplink message 615 based on the PDB of the traffic flow for the uplink message 615, and the UE 115-e may not need to be awake to monitor for signaling scheduling a retransmission. Therefore, as described herein, the UE 115-e may receive signaling from the network entity 105-e configuring the UE 115-e to switch a receiver of the UE 115-e (e.g., a main receiver) to a sleep state after transmitting the uplink message 615. In some aspects, as described with reference to FIG. 5, the UE 115-e may transmit a control signal 640 indicating that the UE 115-e will switch the receiver of the UE 115-e after transmitting the uplink message 615.

In some cases, after transmitting the uplink message 615, the main receiver of the UE 115-e may transition to a sleep state and a WUR of the UE 115-e may remain in an awake state and monitor for one or more WUSs 645 transmitted by the network entity 105-e. In some examples, the network entity 105-e may transmit the WUS 645 to the UE 115-e to indicate that the network entity 105-e unsuccessfully decoded the uplink message 615. Therefore, the UE 115-e may switch the receiver of the UE 115-e (e.g., the main receiver) to an awake state and start the uplink retransmission timer 635 in response to the WUS 645. Further, after switching the main receiver of the UE 115-e to an awake state, the UE 115-e may monitor for and receive a control message from the network entity 105-e during a PDCCH monitoring period 625-b and while the uplink retransmission timer 635 remains active. Here, the control message indicates scheduling information for a retransmission of the uplink message 615. The UE 115-e may transmit the retransmission of the uplink message 615 to the network entity 105-e in accordance with the scheduling information indicated via the control message from the network entity 105-e.

In some aspects, after receiving the WUS 645, the UE 115-e may start the uplink retransmission timer 635. In some cases, the PDCCH monitoring period 625-b may correspond to at least a portion of the uplink retransmission timer 635, and the UE 115-e may monitor for a control message while the uplink retransmission timer 635 remains active during the PDCCH monitoring period 625-b. In some cases, the receiver of the UE 115-e (e.g., the main receiver of the UE 115-e) may be switched to an awake state an interval of time 650 after receiving the WUS 645 from the network entity 105-e. Here, the UE 115-e may switch the receiver of the UE 115-e (e.g., the main receiver of the UE 115-e) to the awake state after an interval of time 650 starting after the WUS 645 is received. Thus, in some cases, the UE 115-c may begin to perform PDCCH monitoring some amount of time after the uplink retransmission timer 635 is started (e.g., based on the timing of the WUS 645, based on capabilities of the UE 115-e to transition to the awake state, or the like).

In some examples, the UE 115-e may receive a WUS 645 that further includes the scheduling information or parameters for transmitting the retransmission of the uplink message 615. As an example, the scheduling parameters carried by the WUS 645 may include an indication of time/frequency resources (or other parameters that would otherwise be carried by some scheduling messages, such as DCI) associated with the retransmission of the uplink message 615. As such, the UE 115-e may transmit the retransmission of the uplink message 615 after receiving the WUS 645 using the scheduling information.

Additionally, or alternatively, while the RTT timer 630 or the uplink retransmission timer 635 is active, the UE 115-e may receive a WUS 645 indicating that a retransmission of the uplink message 615 is canceled based on the processing time for the retransmission of the uplink message 615 exceeding the PDB of the traffic flow. In response to the WUS 645, the UE 115-e may transition to a sleep state, for example, for a remainder of the uplink retransmission timer 635, which may save power at the UE 115-e. Further, for the uplink message 615, the PDB information associated with a packet of the uplink message 615 may be signaled to the network entity, where the PDB information may be explicitly indicated for the network entity 105-e (e.g., to assist the network entity with a determination of whether the retransmission of the uplink message 615 will exceed the PDB).

In some cases, when transmitting the retransmission of the uplink message 615, the UE 115-e may transmit a full copy of the uplink message 615 or a portion of the uplink message. For example, the UE 115-e may determine, based on the remaining time in the PDB of the traffic flow for the uplink message 615, whether there is enough time for the network entity 105-e to receive and decode a full copy of the uplink message 615 or receive and decode a portion of the uplink message 615. In some examples, when the network entity 105-e receives a portion of the uplink message 615, the network entity 105-e may merge the retransmission of the uplink message 615 with the initial uplink message 615 before decoding the retransmission of the uplink message 615. When transmitting the portion of the uplink message 615, the UE 115-e may include some redundant information or copies of information previously decoded by the network entity 105-e.

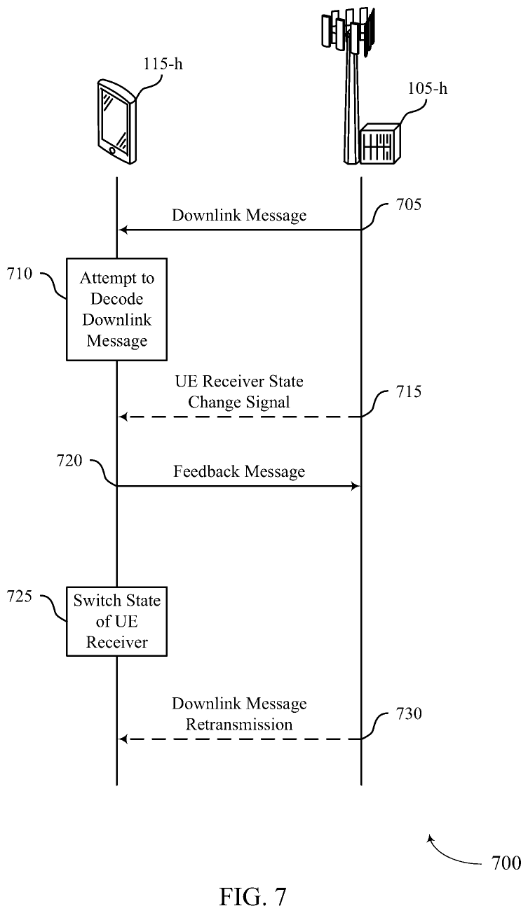

FIG. 7 shows an example of a process flow 700 that supports dynamic monitoring of retransmission scheduling according to PDBs in accordance with one or more aspects of the present disclosure. In some examples, the process flow 700 may implement or be implemented by the wireless communications system 100, the wireless communications system 200, the wireless communications system 300, the wireless communications system 400, the wireless communications system 500, or the wireless communications system 600. For example, the process flow 700 may include a UE 115-h and a network entity 105-h, which may be examples of devices described herein with reference to FIG. 1.

In the following description of the process flow 700, the operations between the UE 115-h and the network entity 105-h may be performed in different orders or at different times. Some operations may also be left out of the process flow 700, or other operations may be added. Although the UE 115-h and the network entity 105-h are shown performing the operations of the process flow 700, some aspects of some operations may also be performed by one or more other wireless devices.

At 705, the network entity 105-h may transmit, to the UE 115-h, a downlink message associated with a traffic flow having a PDB. The downlink message may be an XR data transmission and may be associated with a traffic flow (e.g., downlink traffic flow A or H described in Table 1). Further, in some examples, the network entity 105-h may transmit the downlink message as a PDSCH message after transmitting a message during a PDCCH monitoring period at the UE 115-h, where the message schedules the downlink message.

At 710, the UE 115-h may attempt to decode the downlink message using one or more decoders at the UE 115-h. In some cases, the UE 115-h may successfully decode the downlink message and in some other cases, the UE 115-h may fail to decode the downlink message successfully.

At 715, the network entity 105-h may optionally transmit signaling including an indication that the UE 115-h is to switch to a sleep state after transmitting a feedback message based on the PDB. In some cases, the feedback message may indicate whether the UE 115-h successfully decoded the downlink message from the network entity 105-h. As such, in some examples, the UE 115-h may receive the signaling from the network entity 105-h prior to transmitting the feedback message to the network entity 105-h at 720.

In some examples, the signaling from the network entity 105-h may include an indication for the UE 115-h to switch a receiver of the UE 115-h to a sleep state immediately after transmitting the feedback message based on a processing time for a retransmission of the downlink message exceeding the PDB. The signaling may further indicate that the receiver of the UE 115-h may remain in the sleep state until the expiration of one or more timers. In some cases, the network entity 105-h may transmit the signaling to the UE 115-h via a DCI that scheduled the downlink message. In some other cases, the network entity 105-h may transmit the signaling to the UE 115-h via an RRC, a MAC-CE, or both, to indicate a configuration for the receiver of the UE 115-h to the sleep state immediately after transmitting the feedback message. In some other examples, the UE 115-h may receive the signaling from the network entity 105-h prior to transmitting the feedback message, where the signaling may indicate to switch the receiver of the UE 115-h to the sleep state immediately after transmitting the feedback message when the feedback message indicates unsuccessful decoding.

At 720, the UE 115-h may transmit, to the network entity 105-h, a feedback message indicating unsuccessful decoding of the downlink message associated with the traffic flow having the PDB. For example, the signal quality between the network entity 105-h and the UE 115-h may be low, the network entity 105-h and the UE 115-h may be separated by a relatively large distance, there may be interference at the UE 115-h, or any combination thereof causing the UE 115-h to be unable to successfully decode the downlink message.

At 725, the UE 115-h may switch the receiver of the UE 115-h to the sleep state after transmitting the feedback message at 720 that may indicate that the UE 115-h unsuccessfully decoded downlink message. The UE 115-h may switch the receiver of the UE 115-h to the sleep state based on the PDB, the signaling from the network entity 105-h, or both.

In some examples, after switching the receiver of the UE 115-h to the sleep state, the UE 115-h may receive, from the network entity 105-h, a WUS including an indication to switch the receiver of the UE 115-h to an awake state. In some cases, the WUS may indicate to switch the receiver of the UE 115-h to an awake state to monitor for a control message scheduling a retransmission of the downlink message and to monitor for the retransmission of the downlink message. The network entity 105-h may transmit the WUS based on a processing time for the retransmission of the downlink message satisfying the PDB. As such, the UE 115-h may switch the receiver of the UE 115-h to the awake state in response to the WUS. Additionally, or alternatively, the receiver may be switched to the awake state in accordance with an interval after receiving the WUS. The UE 115-h may then receive the control message scheduling the retransmission of the downlink message while a retransmission timer may be active. Thus, at 730, following receiving the control message, the UE 115-h may receive the retransmission of the downlink message based on the receiver being in the awake state and in accordance with the control message.

In some other examples, after switching the receiver of the UE 115-h to the sleep state, the UE 115-h may receive, from the network entity 105-h, a WUS including an indication to switch the receiver of the UE 115-h to an awake state based on a processing time for the retransmission of the downlink message satisfying the PDB. Further, the WUS may also indicate scheduling parameters for receiving the retransmission of the downlink message. As such, the UE 115-h may refrain from monitoring for the control message from the network entity 105-h scheduling the retransmission of the downlink message. Therefore, at 730, after the UE 115-h receives the WUS, the UE 115-h may monitor for and receive the retransmission of the downlink message, from the network entity 105-h based on the receiver of the UE 115-h being in the awake state and in accordance with the scheduling parameters included in the WUS.

Additionally, or alternatively, the receiver of the UE 115-h may be in an awake state immediately after transmitting the feedback message and while one or more timers may be active. As such, the UE 115-h may receive signaling from the network entity 105-h including a WUS indicating that the retransmission of the downlink message may be canceled. The retransmission of the downlink message may be canceled based on the processing time of the retransmission of the downlink message exceeding the PDB. Following receiving the WUS canceling the retransmission of the downlink message, the UE 115-h may switch the receiver to the sleep state in response to the WUS. In some cases, when the receiver of the UE 115-h may in the awake state and the one or more timers may be active, the UE 115-h may receive signaling from the network entity 105-h including an indication that the retransmission of the downlink message may be canceled. The retransmission of the downlink message may be canceled based on the UE 115-h performing one or more measurements during at least one measurement gap and the processing time of the retransmission of the downlink message exceeding the PDB based on the one or more measurements. As such, the UE 115-h may switch the receiver of the UE 115-h to the sleep state in response to the signaling from the network entity 105-h.

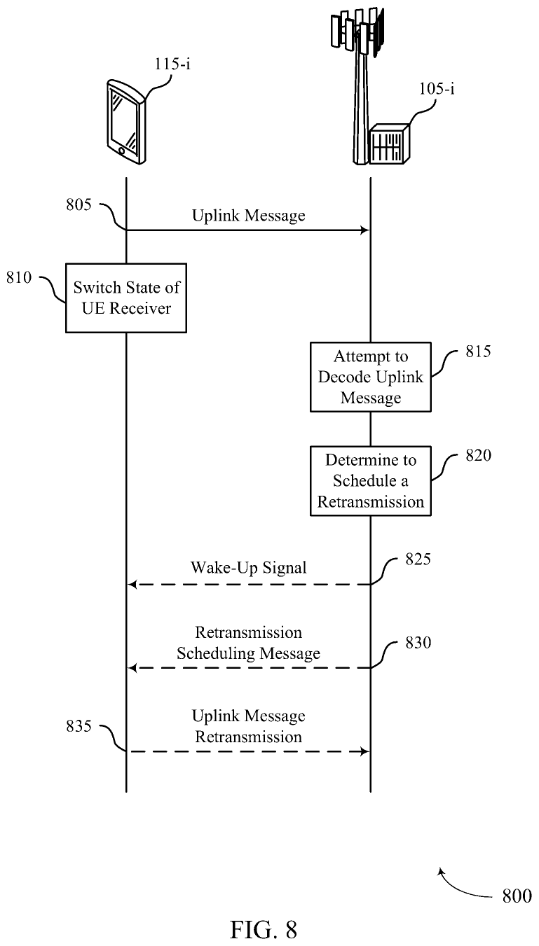

FIG. 8 shows an example of a process flow 800 that supports dynamic monitoring of retransmission scheduling according to PDBs in accordance with one or more aspects of the present disclosure. In some examples, the process flow 800 may implement or be implemented by the wireless communications system 100, the wireless communications system 200, the wireless communications system 300, the wireless communications system 400, the wireless communications system 500, or the wireless communications system 600. For example, the process flow 800 may include a UE 115-i and a network entity 105-i which may be examples of devices described herein with reference to FIG. 1

In the following description of the process flow 800, the operations between the UE 115-i and the network entity 105-i may be performed in different orders or at different times. Some operations may also be left out of the process flow 800, or other operations may be added. Although the UE 115-i and the network entity 105-i are shown performing the operations of the process flow 800, some aspects of some operations may also be performed by one or more other wireless devices.

At 805, the UE 115-i may transmit an uplink message, to the network entity 105-i associated with a traffic flow having a PDB. The uplink message may be an XR data transmission and may be associated with an uplink traffic flow B, C1, F, E, or G described in Table 1. Further, in some examples, the UE 115-i may transmit the uplink message as a PUSCH message in response to a message received from the network entity 105-i during a PDCCH monitoring period at the UE 115-i, where the message schedules the downlink message. At 810, the UE 115-i may switch a receiver of the UE 115-i to a sleep state after transmitting the uplink message. The receiver of the UE 115-i may be switched to the sleep state based on the PDB of the traffic flow for the uplink message, signaling from the network entity, or both.

In some examples, the UE 115-i may transmit a control signal to the network entity 105-i including an indication that the receiver of the UE 115-i may switch to the sleep state immediately after transmitting the uplink message based on a processing time for a retransmission of the uplink message exceeding the PDB. Further, the receiver of the UE 115-i may remain in the sleep state until one or more timers expire based on the PDB of the traffic flow for the uplink message. In some cases, the UE 115-i may transmit the control signal via a UCI where the indication may be a one-bit indicator included in the UCI. In some other cases, the UCI, the one-bit indicator, or both may be multiplexed with the uplink message transmitted by the UE 115-i at 810.

At 815, following the network entity 105-i receiving the uplink message from the UE 115-i, the network entity 105-i may attempt to decode the uplink message. In some cases, the network entity 105-i may decode the uplink message successfully or in some other cases, the network entity 105-i may decode the uplink message unsuccessfully. As such, at 820, the network entity 105-i may determine whether to transmit a downlink message scheduling a retransmission of the uplink message when the network entity 105-i unsuccessfully decodes the uplink message. The determination may be based on the PDB of the traffic flow for the uplink message.

At 825, the UE 115-i may receive a WUS from the network entity 105-i indicating that the network entity 105-i unsuccessfully decoded the uplink message. As such, the UE 115-i may switch the receiver of the UE 115-i to an awake state in response to the WUS. In some cases, at 830, the UE 115-i may receive a control message from the network entity 105-i scheduling a retransmission of the uplink message. Following, the UE 115-i may receive the control message from the network entity 105-i based on monitoring a control channel for the control message while a retransmission timer may be active. In some other cases, the WUS may include the indication to switch the receiver of the UE 115-i to the awake state and indicate scheduling parameters for transmitting the retransmission of the uplink message.

In some cases, the receiver of the UE 115-i may be in an awake state immediately after transmitting the uplink message, or after receiving the WUS at 835, and while one or more retransmission timers are active. While the receiver of the UE 115-i may be in an awake state, the UE 115-i may receive signaling from the network entity including a WUS indicating that a retransmission of the uplink message may be canceled. The retransmission of the uplink message may be canceled based on a processing time for the retransmission of the uplink message exceeding the PDB. As such, the receiver of the UE 115-i may switch to the sleep state in response to the WUS. Further, in some examples, the UE 115-i may transmit an indication of the PDB associated with the traffic flow for the uplink message to the network entity 105-i. As such, the indication from the network entity 105-i that the retransmission of the uplink message may be canceled may be based on the indication of the PDB from the UE 115-i.

Therefore, in some examples, at 835, the UE 115-i may transmit the retransmission of the uplink message to the network entity 105-i in accordance with the control message. In some other examples, the UE 115-i may transmit the retransmission of the uplink message to the network entity 105-i based on the receiver of the UE 115-i being in the awake state and in accordance with the scheduling parameters indicated via the WUS. In either example, the UE 115-i may determine to retransmit the uplink message as a full copy of the uplink message or as a portion of the uplink message to be merged with the initial transmission of the uplink message transmitted to the network entity 105-i at 805. As such the retransmission of the uplink message transmitted by the UE 115-i to the network entity 105-i may be the full copy of the uplink message or the portion of the uplink message.

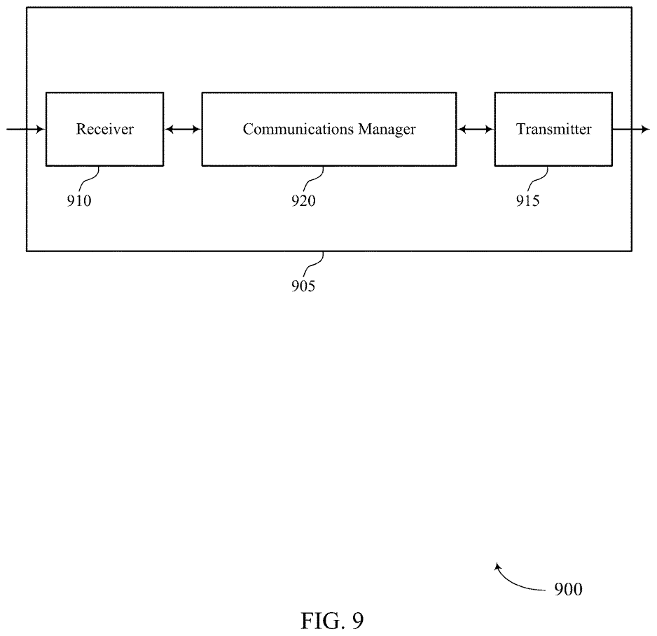

FIG. 9 shows a block diagram 900 of a device 905 that supports dynamic monitoring of retransmission scheduling according to PDBs in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to dynamic monitoring of retransmission scheduling according to PDBs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to dynamic monitoring of retransmission scheduling according to PDBs). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of dynamic monitoring of retransmission scheduling according to PDBs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 is capable of, configured to, or operable to support a means for transmitting, to a network entity, a feedback message indicating unsuccessful decoding of a downlink message, the downlink message being associated with a traffic flow having a PDB. The communications manager 920 is capable of, configured to, or operable to support a means for switching a receiver of the UE to a sleep state after transmitting the feedback message indicating the unsuccessful decoding, the receiver switching to the sleep state based on the PDB or signaling from the network entity, or both.

Additionally, or alternatively, the communications manager 920 may support wireless communications at a UE in accordance with examples as disclosed herein. For example, the communications manager 920 is capable of, configured to, or operable to support a means for transmitting, to a network entity, an uplink message associated with a traffic flow having a PDB. The communications manager 920 is capable of, configured to, or operable to support a means for switching a receiver of the UE to a sleep state after transmitting the uplink message, the receiver switching to the sleep state based on the PDB or signaling from the network entity, or both.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques that enable the UE to switch a receiver of the UE to a sleep state after receiving a downlink message or after transmitting an uplink message for reduced processing, reduced power consumption, and more efficient utilization of communication resources. In particular, the device 905 (e.g., the at least one processor controlling or otherwise coupled with the receiver 910, the transmitter 915, the communications manager 920, or a combination thereof) may support techniques that enable the UE to avoid waking up (e.g., powering up one or more components) to receive or transmit a retransmission, which may be based on whether processing one or more retransmissions satisfies a PDB associated with a traffic flow.

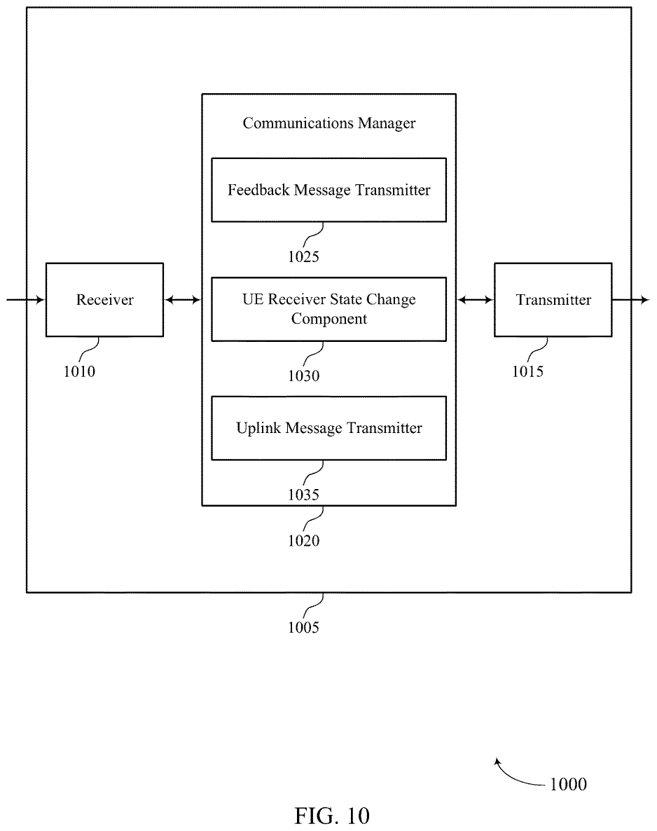

FIG. 10 shows a block diagram 1000 of a device 1005 that supports dynamic monitoring of retransmission scheduling according to PDBs in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to dynamic monitoring of retransmission scheduling according to PDBs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to dynamic monitoring of retransmission scheduling according to PDBs). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of dynamic monitoring of retransmission scheduling according to PDBs as described herein. For example, the communications manager 1020 may include a feedback message transmitter 1025, a UE receiver state change component 1030, an uplink message transmitter 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The feedback message transmitter 1025 is capable of, configured to, or operable to support a means for transmitting, to a network entity, a feedback message indicating unsuccessful decoding of a downlink message, the downlink message being associated with a traffic flow having a PDB. The UE receiver state change component 1030 is capable of, configured to, or operable to support a means for switching a receiver of the UE to a sleep state after transmitting the feedback message indicating the unsuccessful decoding, the receiver switching to the sleep state based on the PDB or signaling from the network entity, or both.

Additionally, or alternatively, the communications manager 1020 may support wireless communications at a UE in accordance with examples as disclosed herein. The uplink message transmitter 1035 is capable of, configured to, or operable to support a means for transmitting, to a network entity, an uplink message associated with a traffic flow having a PDB. The UE receiver state change component 1030 is capable of, configured to, or operable to support a means for switching a receiver of the UE to a sleep state after transmitting the uplink message, the receiver switching to the sleep state based on the PDB or signaling from the network entity, or both.

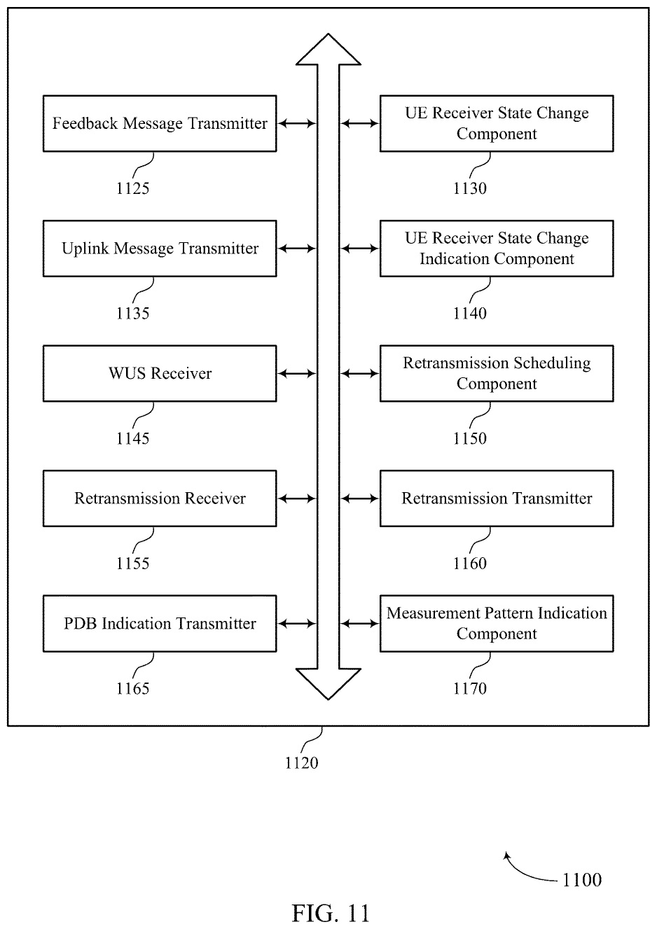

FIG. 11 shows a block diagram 1100 of a communications manager 1120 that supports dynamic monitoring of retransmission scheduling according to PDBs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of dynamic monitoring of retransmission scheduling according to PDBs as described herein. For example, the communications manager 1120 may include a feedback message transmitter 1125, a UE receiver state change component 1130, an uplink message transmitter 1135, a UE receiver state change indication component 1140, a WUS receiver 1145, a retransmission scheduling component 1150, a retransmission receiver 1155, a retransmission transmitter 1160, a PDB indication transmitter 1165, a measurement pattern indication component 1170, or any combination thereof. Each of these components, or components or subcomponents thereof (e.g., one or more processors, one or more memories), may communicate, directly or indirectly, with one another (e.g., via one or more buses).

The communications manager 1120 may support wireless communications at a UE in accordance with examples as disclosed herein. The feedback message transmitter 1125 is capable of, configured to, or operable to support a means for transmitting, to a network entity, a feedback message indicating unsuccessful decoding of a downlink message, the downlink message being associated with a traffic flow having a PDB. The UE receiver state change component 1130 is capable of, configured to, or operable to support a means for switching a receiver of the UE to a sleep state after transmitting the feedback message indicating the unsuccessful decoding, the receiver switching to the sleep state based on the PDB or signaling from the network entity, or both.

In some examples, the UE receiver state change indication component 1140 is capable of, configured to, or operable to support a means for receiving the signaling from the network entity prior to transmitting the feedback message, the signaling including an indication to switch the receiver to the sleep state immediately after transmitting the feedback message based on a processing time for a retransmission of the downlink message exceeding the PDB, where the receiver remains in the sleep state until one or more timers expire in accordance with the signaling.

In some examples, to support receiving the signaling, the UE receiver state change indication component 1140 is capable of, configured to, or operable to support a means for receiving the signaling via DCI that schedules the downlink message.

In some examples, the UE receiver state change indication component 1140 is capable of, configured to, or operable to support a means for receiving the signaling from the network entity prior to transmitting the feedback message, the signaling including an indication to switch the receiver to the sleep state immediately after transmitting the feedback message when the feedback message indicates the unsuccessful decoding. In some examples, the WUS receiver 1145 is capable of, configured to, or operable to support a means for receiving, from the network entity, a WUS including an indication to switch the receiver to an awake state to monitor for a control message scheduling a retransmission of the downlink message and monitor for the retransmission of the downlink message based on a processing time for the retransmission of the downlink message satisfying the PDB. In some examples, the UE receiver state change component 1130 is capable of, configured to, or operable to support a means for switching the receiver to the awake state in response to the WUS. In some examples, the retransmission scheduling component 1150 is capable of, configured to, or operable to support a means for receiving the control message scheduling the retransmission of the downlink message while a retransmission timer is active. In some examples, the retransmission receiver 1155 is capable of, configured to, or operable to support a means for receiving, from the network entity, the retransmission of the downlink message based on the receiver being in the awake state, where the retransmission is received in accordance with the control message.

In some examples, the receiver is switched to the awake state in accordance with an interval after receiving the WUS.

In some examples, to support receiving the signaling, the UE receiver state change indication component 1140 is capable of, configured to, or operable to support a means for receiving an RRC message or a MAC-CE, or both, indicating a configuration to switch the receiver to the sleep state immediately after transmitting the feedback message.

In some examples, the WUS receiver 1145 is capable of, configured to, or operable to support a means for receiving, from the network entity, a WUS including an indication to switch the receiver to an awake state to monitor for a retransmission of the downlink message based on a processing time for the retransmission of the downlink message satisfying the PDB, the WUS further indicating scheduling parameters for receiving the retransmission of the downlink message. In some examples, the retransmission receiver 1155 is capable of, configured to, or operable to support a means for receiving the retransmission of the downlink message based on the receiver being in the awake state and in accordance with the scheduling parameters.

In some examples, the receiver is in an awake state immediately after transmitting the feedback message and while one or more timers are active, and the UE receiver state change indication component 1140 is capable of, configured to, or operable to support a means for receiving the signaling from the network entity, the signaling including a WUS including an indication that a retransmission of the downlink message is canceled based on a processing time for the retransmission of the downlink message exceeding the PDB, where the receiver is switched to the sleep state in response to the WUS.

In some examples, the receiver is in an awake state immediately after transmitting the feedback message and while one or more timers are active, and the UE receiver state change indication component 1140 is capable of, configured to, or operable to support a means for receiving the signaling from the network entity, the signaling including an indication that a retransmission of the downlink message is canceled based on the UE performing one or more measurements during at least one measurement gap and a processing time for the retransmission of the downlink message exceeding the PDB based on the one or more measurements, where the receiver is switched to the sleep state in response to the signaling.

In some examples, the signaling includes DCI, or a WUS, or both.

In some examples, the UE receiver state change component 1130 is capable of, configured to, or operable to support a means for transmitting, to the network entity, an uplink message indicating that the UE is to perform the one or more measurements, where the indication that the retransmission of the downlink message is canceled is in response to the uplink message.

In some examples, the uplink message requests that the retransmission of the downlink message be canceled based on the PDB.

In some examples, the receiver is switched to the sleep state immediately after transmitting the uplink message.

In some examples, the measurement pattern indication component 1170 is capable of, configured to, or operable to support a means for receiving, from the network entity, a message including an indication to select a measurement pattern from a set of measurement patterns based on the PDB, where the measurement pattern supports a processing time for the retransmission of the downlink message that satisfies the PDB.

Additionally, or alternatively, the communications manager 1120 may support wireless communications at a UE in accordance with examples as disclosed herein. The uplink message transmitter 1135 is capable of, configured to, or operable to support a means for transmitting, to a network entity, an uplink message associated with a traffic flow having a PDB. In some examples, the UE receiver state change component 1130 is capable of, configured to, or operable to support a means for switching a receiver of the UE to a sleep state after transmitting the uplink message, the receiver switching to the sleep state based on the PDB or signaling from the network entity, or both.

In some examples, the UE receiver state change indication component 1140 is capable of, configured to, or operable to support a means for transmitting, to the network entity, a control signal including an indication that the receiver will switch to the sleep state immediately after transmitting the uplink message based on a processing time for a retransmission of the uplink message exceeding the PDB, where the receiver remains in the sleep state until one or more timers expire based on the PDB.

In some examples, to support transmitting the control signal, the UE receiver state change indication component 1140 is capable of, configured to, or operable to support a means for transmitting the control signal via UCI, where the indication includes a one-bit indicator included in the UCI.

In some examples, the UCI is multiplexed with the uplink message.

In some examples, the WUS receiver 1145 is capable of, configured to, or operable to support a means for receiving, from the network entity, a WUS including an indication that the uplink message was unsuccessfully decoded. In some examples, the UE receiver state change component 1130 is capable of, configured to, or operable to support a means for switching the receiver to an awake state in response to the WUS. In some examples, the UE receiver state change indication component 1140 is capable of, configured to, or operable to support a means for receiving, from the network entity, a control message scheduling a retransmission of the uplink message, the control message received based on monitoring a control channel for the control message while a retransmission timer is active. In some examples, the retransmission transmitter 1160 is capable of, configured to, or operable to support a means for transmitting, to the network entity, the retransmission of the uplink message in accordance with the control message.

In some examples, the retransmission transmitter 1160 is capable of, configured to, or operable to support a means for determining to retransmit the uplink message as a full copy of the uplink message or a portion of the uplink message to be merged with the uplink message initially transmitted to the network entity, the determination being based on the PDB, where the retransmission of the uplink message including the full copy of the uplink message or the portion of the uplink message in accordance with the determination.

In some examples, the WUS receiver 1145 is capable of, configured to, or operable to support a means for receiving, from the network entity, a WUS including an indication to switch the receiver to an awake state to retransmit the uplink message based on a processing time for a retransmission of the uplink message satisfying the PDB, the WUS further indicating scheduling parameters for transmitting the retransmission of the uplink message. In some examples, the retransmission transmitter 1160 is capable of, configured to, or operable to support a means for transmitting the retransmission of the uplink message based on the receiver being in the awake state and in accordance with the scheduling parameters.

In some examples, the receiver is in an awake state immediately after transmitting the uplink message and while one or more timers are active, and the UE receiver state change indication component 1140 is capable of, configured to, or operable to support a means for receiving the signaling from the network entity, the signaling including a WUS including an indication that a retransmission of the uplink message is canceled based on a processing time for the retransmission of the uplink message exceeding the PDB, where the receiver is switched to the sleep state in response to the WUS.

In some examples, the PDB indication transmitter 1165 is capable of, configured to, or operable to support a means for transmitting, to the network entity, an indication of the PDB associated with the traffic flow, where the indication that the retransmission of the uplink message is canceled is based on the indication of the PDB.

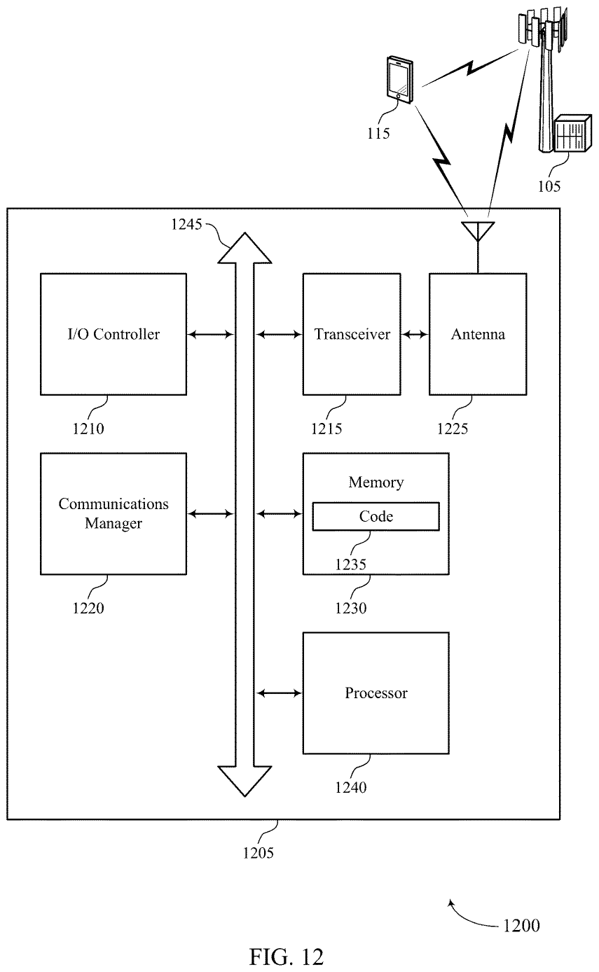

FIG. 12 shows a diagram of a system 1200 including a device 1205 that supports dynamic monitoring of retransmission scheduling according to PDBs in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting dynamic monitoring of retransmission scheduling according to PDBs). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein.

The communications manager 1220 may support wireless communications at a UE in accordance with examples as disclosed herein. For example, the communications manager 1220 is capable of, configured to, or operable to support a means for transmitting, to a network entity, a feedback message indicating unsuccessful decoding of a downlink message, the downlink message being associated with a traffic flow having a PDB. The communications manager 1220 is capable of, configured to, or operable to support a means for switching a receiver of the UE to a sleep state after transmitting the feedback message indicating the unsuccessful decoding, the receiver switching to the sleep state based on the PDB or signaling from the network entity, or both.

Additionally, or alternatively, the communications manager 1220 may support wireless communications at a UE in accordance with examples as disclosed herein. For example, the communications manager 1220 is capable of, configured to, or operable to support a means for transmitting, to a network entity, an uplink message associated with a traffic flow having a PDB. The communications manager 1220 is capable of, configured to, or operable to support a means for switching a receiver of the UE to a sleep state after transmitting the uplink message, the receiver switching to the sleep state based on the PDB or signaling from the network entity, or both.

By including or configuring the communications manager 1220 in accordance with examples as described herein, the device 1205 may support techniques that enable the UE to switch a receiver of the UE to a sleep state after receiving a downlink message or after transmitting an uplink message for enhanced power savings. In particular, the device 1205 may support techniques that enable the UE to avoid waking up (e.g., powering up one or more components) to receive or transmit a retransmission, which may be based on whether processing the retransmission satisfies a PDB of a traffic flow. Such techniques supported by the device 1205 may be associated with improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of dynamic monitoring of retransmission scheduling according to PDBs as described herein, or the at least one processor 1240 and the at least one memory 1230 may be otherwise configured to, individually or collectively, perform or support such operations.

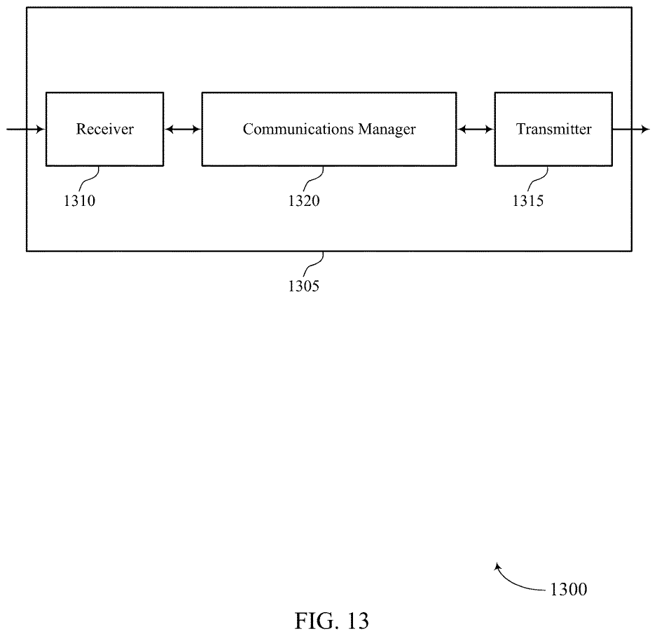

FIG. 13 shows a block diagram 1300 of a device 1305 that supports dynamic monitoring of retransmission scheduling according to PDBs in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of dynamic monitoring of retransmission scheduling according to PDBs as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor. If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 is capable of, configured to, or operable to support a means for transmitting, to a UE, a downlink message associated with a traffic flow having a PDB. The communications manager 1320 is capable of, configured to, or operable to support a means for receiving, from the UE, a feedback message indicating unsuccessful decoding of the downlink message. The communications manager 1320 is capable of, configured to, or operable to support a means for transmitting, to the UE, signaling including an indication that the UE switch to a sleep state after transmitting the feedback message based on the PDB.

Additionally, or alternatively, the communications manager 1320 may support wireless communications at a network entity in accordance with examples as disclosed herein. For example, the communications manager 1320 is capable of, configured to, or operable to support a means for receiving, from a UE, an uplink message associated with a traffic flow having a PDB. The communications manager 1320 is capable of, configured to, or operable to support a means for determining whether to transmit a downlink message scheduling a retransmission of the uplink message when the uplink message is unsuccessfully decoded, where the determining is based on the PDB of the traffic flow.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques that enable the UE to switch a receiver of the UE to a sleep state after receiving a downlink message or after transmitting an uplink message for reduced processing, reduced power consumption, and more efficient utilization of communication resources. In particular, the device 1305 (e.g., the at least one processor controlling or otherwise coupled with the receiver 1310, the transmitter 1315, the communications manager 1320, or a combination thereof) may support techniques that enable the UE to avoid waking up (e.g., powering up one or more components) to receive or transmit a retransmission, which may be based on whether processing one or more retransmissions satisfies a PDB associated with a traffic flow.

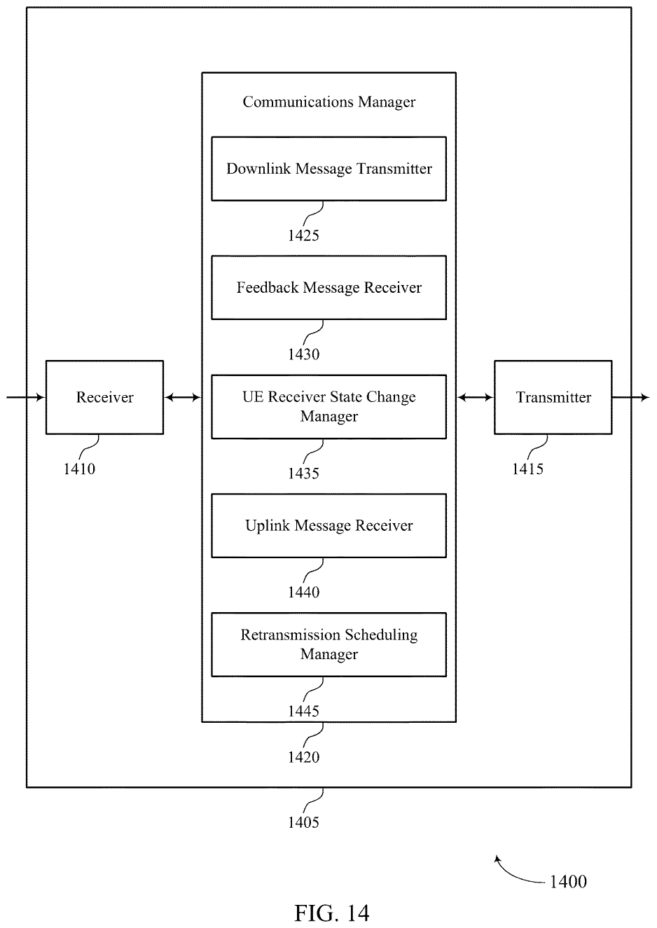

FIG. 14 shows a block diagram 1400 of a device 1405 that supports dynamic monitoring of retransmission scheduling according to PDBs in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of dynamic monitoring of retransmission scheduling according to PDBs as described herein. For example, the communications manager 1420 may include a downlink message transmitter 1425, a feedback message receiver 1430, a UE receiver state change manager 1435, an uplink message receiver 1440, a retransmission scheduling manager 1445, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The downlink message transmitter 1425 is capable of, configured to, or operable to support a means for transmitting, to a UE, a downlink message associated with a traffic flow having a PDB. The feedback message receiver 1430 is capable of, configured to, or operable to support a means for receiving, from the UE, a feedback message indicating unsuccessful decoding of the downlink message. The UE receiver state change manager 1435 is capable of, configured to, or operable to support a means for transmitting, to the UE, signaling including an indication that the UE switch to a sleep state after transmitting the feedback message based on the PDB.

Additionally, or alternatively, the communications manager 1420 may support wireless communications at a network entity in accordance with examples as disclosed herein. The uplink message receiver 1440 is capable of, configured to, or operable to support a means for receiving, from a UE, an uplink message associated with a traffic flow having a PDB. The retransmission scheduling manager 1445 is capable of, configured to, or operable to support a means for determining whether to transmit a downlink message scheduling a retransmission of the uplink message when the uplink message is unsuccessfully decoded, where the determining is based on the PDB of the traffic flow.

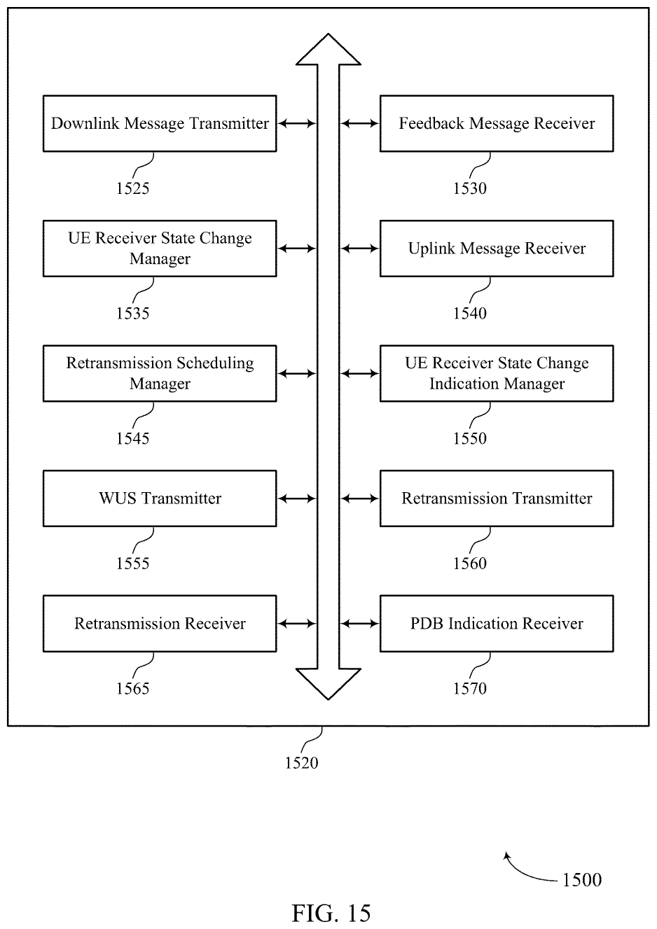

FIG. 15 shows a block diagram 1500 of a communications manager 1520 that supports dynamic monitoring of retransmission scheduling according to PDBs in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of dynamic monitoring of retransmission scheduling according to PDBs as described herein. For example, the communications manager 1520 may include a downlink message transmitter 1525, a feedback message receiver 1530, a UE receiver state change manager 1535, an uplink message receiver 1540, a retransmission scheduling manager 1545, a UE receiver state change indication manager 1550, a WUS transmitter 1555, a retransmission transmitter 1560, a retransmission receiver 1565, a PDB indication receiver 1570, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The downlink message transmitter 1525 is capable of, configured to, or operable to support a means for transmitting, to a UE, a downlink message associated with a traffic flow having a PDB. The feedback message receiver 1530 is capable of, configured to, or operable to support a means for receiving, from the UE, a feedback message indicating unsuccessful decoding of the downlink message. The UE receiver state change manager 1535 is capable of, configured to, or operable to support a means for transmitting, to the UE, signaling including an indication that the UE switch to a sleep state after transmitting the feedback message based on the PDB.

In some examples, to support transmitting the signaling, the UE receiver state change indication manager 1550 is capable of, configured to, or operable to support a means for transmitting the signaling to the UE prior to receiving the feedback message, the signaling including an indication to switch the receiver to the sleep state immediately after transmitting the feedback message based on a processing time for a retransmission of the downlink message exceeding the PDB.

In some examples, the signaling is transmitted via DCI that schedules the downlink message.

In some examples, to support transmitting the signaling, the UE receiver state change indication manager 1550 is capable of, configured to, or operable to support a means for transmitting the signaling to the UE prior to receiving the feedback message, the signaling including an indication to switch to the sleep state immediately after transmitting the feedback message when the feedback message indicates the unsuccessful decoding. In some examples, to support transmitting the signaling, the WUS transmitter 1555 is capable of, configured to, or operable to support a means for transmitting, to the UE, a WUS including an indication to switch to an awake state to monitor for a control message scheduling a retransmission of the downlink message and monitor for the retransmission of the downlink message based on a processing time for the retransmission of the downlink message satisfying the PDB. In some examples, to support transmitting the signaling, the retransmission scheduling manager 1545 is capable of, configured to, or operable to support a means for transmitting the control message scheduling the retransmission of the downlink message while a retransmission timer is active. In some examples, to support transmitting the signaling, the retransmission transmitter 1560 is capable of, configured to, or operable to support a means for transmitting the retransmission of the downlink message to the UE in accordance with the control message.

In some examples, the retransmission of the downlink message is transmitted in accordance with an interval after transmitting the WUS.

In some examples, to support transmitting the signaling, the UE receiver state change indication manager 1550 is capable of, configured to, or operable to support a means for transmitting an RRC message or a MAC-CE, or both, indicating a configuration to switch to the sleep state immediately after transmitting the feedback message.

In some examples, the UE receiver state change indication manager 1550 is capable of, configured to, or operable to support a means for transmitting, to the UE, a WUS including an indication to switch to an awake state to monitor for a retransmission of the downlink message based on a processing time for the retransmission of the downlink message satisfying the PDB, the WUS further indicating scheduling parameters for receiving the retransmission of the downlink message. In some examples, the retransmission transmitter 1560 is capable of, configured to, or operable to support a means for transmitting the retransmission of the downlink message in accordance with the scheduling parameters.

In some examples, the signaling includes a WUS including an indication that a retransmission of the downlink message is canceled based on a processing time for the retransmission of the downlink message exceeding the PDB.

In some examples, the signaling includes an indication that a retransmission of the downlink message is canceled based on the UE performing one or more measurements during at least one measurement gap and a processing time for the retransmission of the downlink message exceeding the PDB based on the one or more measurements.

Additionally, or alternatively, the communications manager 1520 may support wireless communications at a network entity in accordance with examples as disclosed herein. The uplink message receiver 1540 is capable of, configured to, or operable to support a means for receiving, from a UE, an uplink message associated with a traffic flow having a PDB. The retransmission scheduling manager 1545 is capable of, configured to, or operable to support a means for determining whether to transmit a downlink message scheduling a retransmission of the uplink message when the uplink message is unsuccessfully decoded, where the determining is based on the PDB of the traffic flow.

In some examples, the UE receiver state change indication manager 1550 is capable of, configured to, or operable to support a means for receiving, from the UE, a control signal including an indication that the UE will switch to a sleep state immediately after transmitting the uplink message and until one or more timers expire based on a processing time for the retransmission of the uplink message exceeding the PDB. In some examples, the retransmission scheduling manager 1545 is capable of, configured to, or operable to support a means for determining to refrain from transmitting the downlink message based on receiving the control signal.

In some examples, to support receiving the control signal, the UE receiver state change indication manager 1550 is capable of, configured to, or operable to support a means for receiving the control signal via UCI, where the indication includes a one-bit indicator included in the UCI.

In some examples, the UCI is multiplexed with the uplink message.

In some examples, the WUS transmitter 1555 is capable of, configured to, or operable to support a means for transmitting, to the UE, a WUS including an indication that the uplink message was unsuccessfully decoded. In some examples, the retransmission scheduling manager 1545 is capable of, configured to, or operable to support a means for transmitting, to the UE, the downlink message scheduling the retransmission of the uplink message, the downlink message transmitted while a retransmission timer is active at the UE. In some examples, the retransmission receiver 1565 is capable of, configured to, or operable to support a means for receiving, from the UE, the retransmission of the uplink message in accordance with the downlink message.

In some examples, the retransmission of the uplink message includes a full copy of the uplink message or a portion of the uplink message to be merged with the uplink message initially transmitted by the UE based on the PDB.

In some examples, the WUS transmitter 1555 is capable of, configured to, or operable to support a means for transmitting, to the UE, a WUS including an indication to switch to an awake state to retransmit the uplink message based on a processing time for the retransmission of the uplink message satisfying the PDB, the WUS further indicating scheduling parameters for transmitting the retransmission of the uplink message. In some examples, the retransmission receiver 1565 is capable of, configured to, or operable to support a means for receiving the retransmission of the uplink message in accordance with the scheduling parameters.

In some examples, the UE receiver state change indication manager 1550 is capable of, configured to, or operable to support a means for transmitting signaling to the UE, the signaling including a WUS including an indication that the retransmission of the uplink message is canceled based on a processing time for the retransmission of the uplink message exceeding the PDB.

In some examples, the PDB indication receiver 1570 is capable of, configured to, or operable to support a means for receiving, from the UE, an indication of the PDB associated with the traffic flow, where the indication that the retransmission of the uplink message is canceled is based on the indication of the PDB.

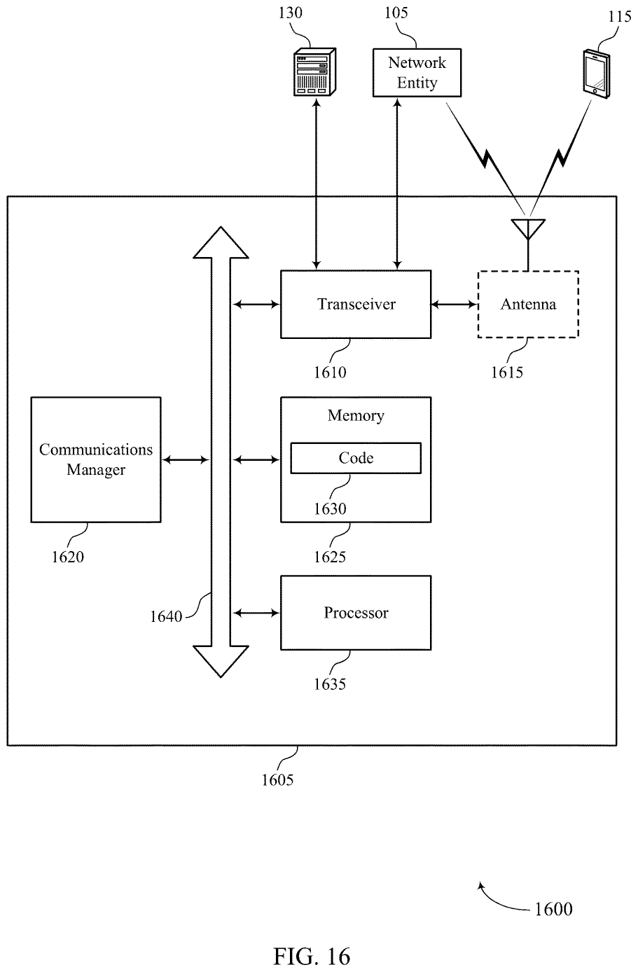

FIG. 16 shows a diagram of a system 1600 including a device 1605 that supports dynamic monitoring of retransmission scheduling according to PDBs in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., a communication link 125, a backhaul communication link 120, a midhaul communication link 162, a fronthaul communication link 168).

The at least one memory 1625 may include RAM, ROM, or any combination thereof. The at least one memory 1625 may store computer-readable, computer-executable code 1630 including instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may contain, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting dynamic monitoring of retransmission scheduling according to PDBs). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some implementations, the at least one processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the at least one processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a network entity in accordance with examples as disclosed herein. For example, the communications manager 1620 is capable of, configured to, or operable to support a means for transmitting, to a UE, a downlink message associated with a traffic flow having a PDB. The communications manager 1620 is capable of, configured to, or operable to support a means for receiving, from the UE, a feedback message indicating unsuccessful decoding of the downlink message. The communications manager 1620 is capable of, configured to, or operable to support a means for transmitting, to the UE, signaling including an indication that the UE switch to a sleep state after transmitting the feedback message based on the PDB.

Additionally, or alternatively, the communications manager 1620 may support wireless communications at a network entity in accordance with examples as disclosed herein. For example, the communications manager 1620 is capable of, configured to, or operable to support a means for receiving, from a UE, an uplink message associated with a traffic flow having a PDB. The communications manager 1620 is capable of, configured to, or operable to support a means for determining whether to transmit a downlink message scheduling a retransmission of the uplink message when the uplink message is unsuccessfully decoded, where the determining is based on the PDB of the traffic flow.

By including or configuring the communications manager 1620 in accordance with examples as described herein, the device 1605 may support techniques that enable the UE to switch a receiver of the UE to a sleep state after receiving a downlink message or after transmitting an uplink message for enhanced power savings. In particular, the device 1605 may support techniques that enable the UE to avoid waking up (e.g., powering up one or more components) to receive or transmit a retransmission, which may be based on whether processing the retransmission satisfies a PDB of a traffic flow. Such techniques supported by the device 1605 may be associated with improved communication reliability, reduced latency, improved user experience related to reduced processing, reduced power consumption, more efficient utilization of communication resources, improved coordination between devices, longer battery life, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of dynamic monitoring of retransmission scheduling according to PDBs as described herein, or the at least one processor 1635 and the at least one memory 1625 may be otherwise configured to, individually or collectively, perform or support such operations.

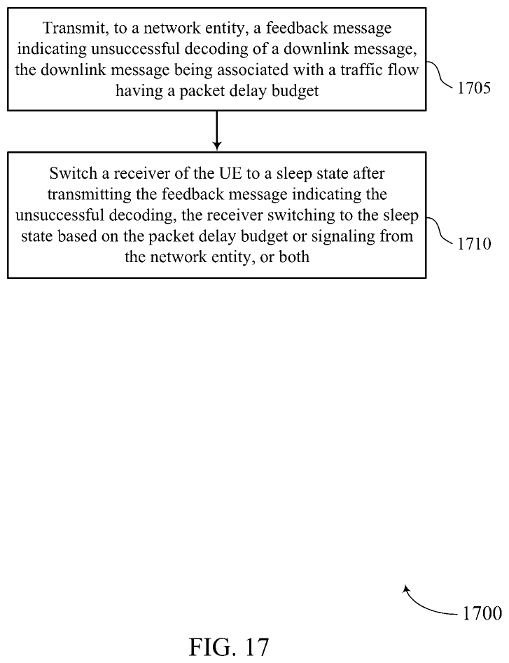

FIG. 17 shows a flowchart illustrating a method 1700 that supports dynamic monitoring of retransmission scheduling according to PDBs in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting, to a network entity, a feedback message indicating unsuccessful decoding of a downlink message, the downlink message being associated with a traffic flow having a PDB. The operations of 1705 may be performed in accordance with examples as disclosed herein. In some examples, aspects of the operations of 1705 may be performed by a feedback message transmitter 1125 as described with reference to FIG. 11.

At 1710, the method may include switching a receiver of the UE to a sleep state after transmitting the feedback message indicating the unsuccessful decoding, the receiver switching to the sleep state based on the PDB or signaling from the network entity, or both. The operations of 1710 may be performed in accordance with examples as disclosed herein. In some examples, aspects of the operations of 1710 may be performed by a UE receiver state change component 1130 as described with reference to FIG. 11.

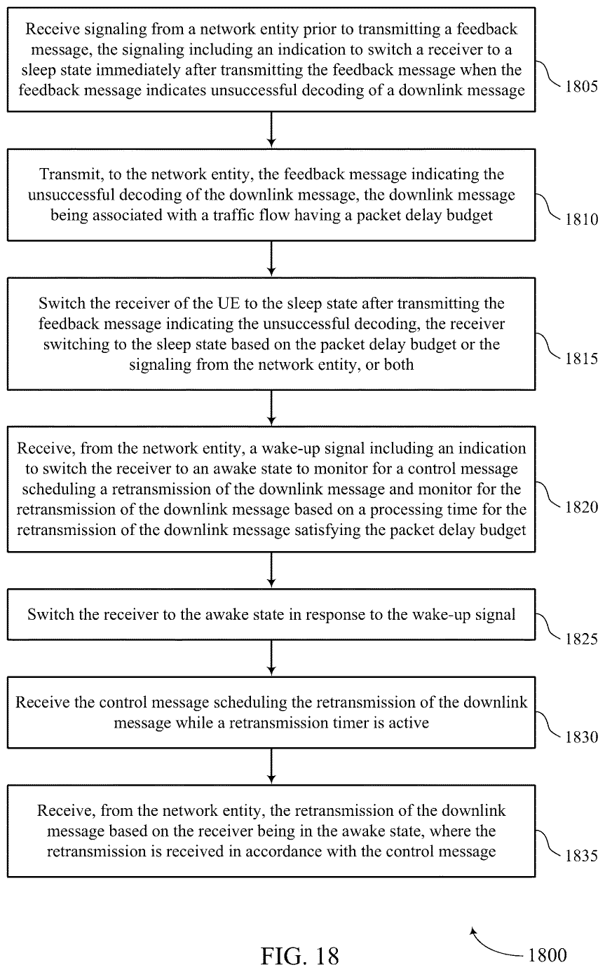

FIG. 18 shows a flowchart illustrating a method 1800 that supports dynamic monitoring of retransmission scheduling according to PDBs in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving signaling from a network entity prior to transmitting a feedback message, the signaling including an indication to switch a receiver of the UE to a sleep state immediately after transmitting the feedback message when the feedback message indicates unsuccessful decoding of the downlink message. The operations of 1805 may be performed in accordance with examples as disclosed herein. In some examples, aspects of the operations of 1805 may be performed by a UE receiver state change indication component 1140 as described with reference to FIG. 11.

At 1810, the method may include transmitting, to the network entity, the feedback message indicating the unsuccessful decoding of the downlink message, the downlink message being associated with a traffic flow having a PDB. The operations of 1810 may be performed in accordance with examples as disclosed herein. In some examples, aspects of the operations of 1810 may be performed by a feedback message transmitter 1125 as described with reference to FIG. 11.

At 1815, the method may include switching the receiver of the UE to the sleep state after transmitting the feedback message indicating the unsuccessful decoding, the receiver switching to the sleep state based on the PDB or the signaling from the network entity, or both. The operations of 1815 may be performed in accordance with examples as disclosed herein. In some examples, aspects of the operations of 1815 may be performed by a UE receiver state change component 1130 as described with reference to FIG. 11.

At 1820, the method may include receiving, from the network entity, a WUS including an indication to switch the receiver to an awake state to monitor for a control message scheduling a retransmission of the downlink message and monitor for the retransmission of the downlink message based on a processing time for the retransmission of the downlink message satisfying the PDB. The operations of 1820 may be performed in accordance with examples as disclosed herein. In some examples, aspects of the operations of 1820 may be performed by a WUS receiver 1145 as described with reference to FIG. 11.

At 1825, the method may include switching the receiver to the awake state in response to the WUS. The operations of 1825 may be performed in accordance with examples as disclosed herein. In some examples, aspects of the operations of 1825 may be performed by a UE receiver state change component 1130 as described with reference to FIG. 11.

At 1830, the method may include receiving the control message scheduling the retransmission of the downlink message while a retransmission timer is active. The operations of 1830 may be performed in accordance with examples as disclosed herein. In some examples, aspects of the operations of 1830 may be performed by a retransmission scheduling component 1150 as described with reference to FIG. 11.

At 1835, the method may include receiving, from the network entity, the retransmission of the downlink message based on the receiver being in the awake state, where the retransmission is received in accordance with the control message. The operations of 1835 may be performed in accordance with examples as disclosed herein. In some examples, aspects of the operations of 1835 may be performed by a retransmission receiver 1155 as described with reference to FIG. 11.

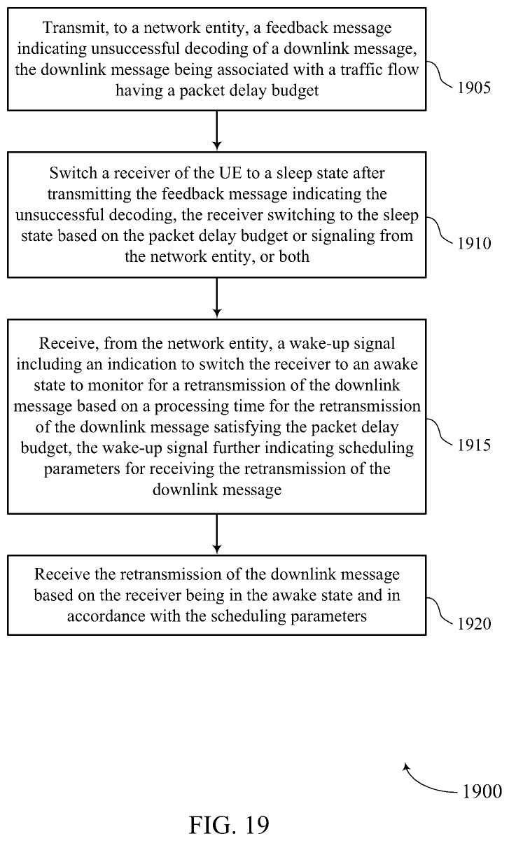

FIG. 19 shows a flowchart illustrating a method 1900 that supports dynamic monitoring of retransmission scheduling according to PDBs in accordance with aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include transmitting, to a network entity, a feedback message indicating unsuccessful decoding of a downlink message, the downlink message being associated with a traffic flow having a PDB. The operations of 1905 may be performed in accordance with examples as disclosed herein. In some examples, aspects of the operations of 1905 may be performed by a feedback message transmitter 1125 as described with reference to FIG. 11.

At 1910, the method may include switching a receiver of the UE to a sleep state after transmitting the feedback message indicating the unsuccessful decoding, the receiver switching to the sleep state based on the PDB or signaling from the network entity, or both. The operations of 1910 may be performed in accordance with examples as disclosed herein. In some examples, aspects of the operations of 1910 may be performed by a UE receiver state change component 1130 as described with reference to FIG. 11.

At 1915, the method may include receiving, from the network entity, a WUS including an indication to switch the receiver to an awake state to monitor for a retransmission of the downlink message based on a processing time for the retransmission of the downlink message satisfying the PDB, the WUS further indicating scheduling parameters for receiving the retransmission of the downlink message. The operations of 1915 may be performed in accordance with examples as disclosed herein. In some examples, aspects of the operations of 1915 may be performed by a WUS receiver 1145 as described with reference to FIG. 11.

At 1920, the method may include receiving the retransmission of the downlink message based on the receiver being in the awake state and in accordance with the scheduling parameters. The operations of 1920 may be performed in accordance with examples as disclosed herein. In some examples, aspects of the operations of 1920 may be performed by a retransmission receiver 1155 as described with reference to FIG. 11.

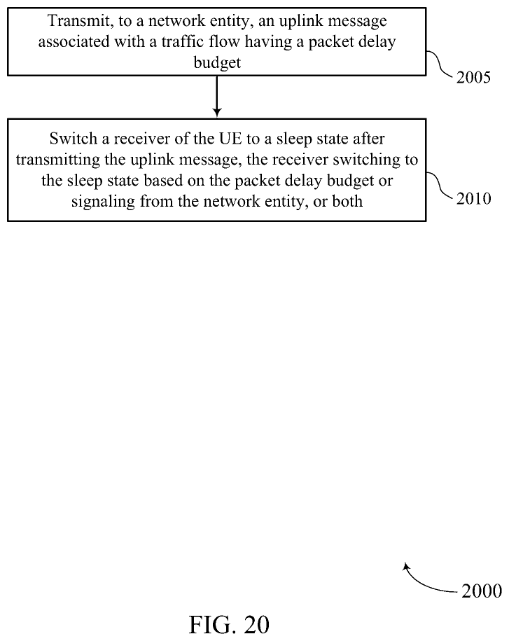

FIG. 20 shows a flowchart illustrating a method 2000 that supports dynamic monitoring of retransmission scheduling according to PDBs in accordance with aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include transmitting, to a network entity, an uplink message associated with a traffic flow having a PDB. The operations of 2005 may be performed in accordance with examples as disclosed herein. In some examples, aspects of the operations of 2005 may be performed by an uplink message transmitter 1135 as described with reference to FIG. 11.

At 2010, the method may include switching a receiver of the UE to a sleep state after transmitting the uplink message, the receiver switching to the sleep state based on the PDB or signaling from the network entity, or both. The operations of 2010 may be performed in accordance with examples as disclosed herein. In some examples, aspects of the operations of 2010 may be performed by a UE receiver state change component 1130 as described with reference to FIG. 11.

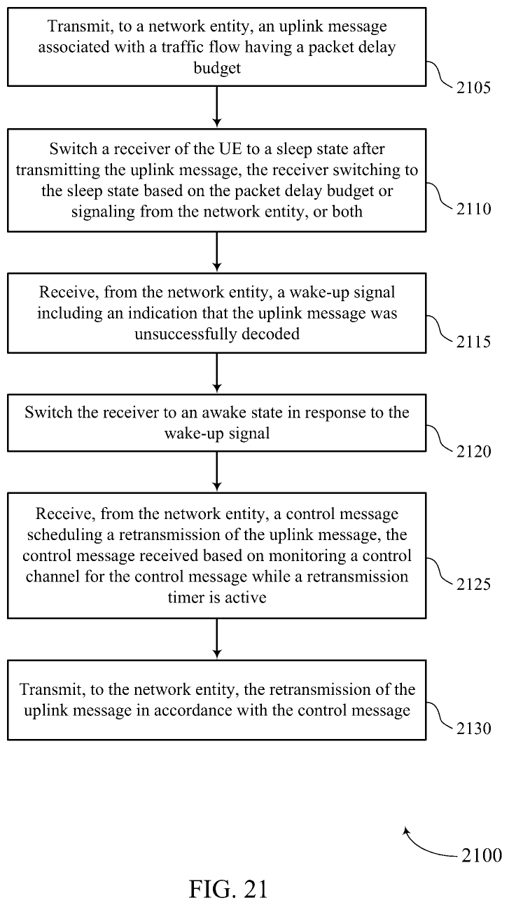

FIG. 21 shows a flowchart illustrating a method 2100 that supports dynamic monitoring of retransmission scheduling according to PDBs in accordance with aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include transmitting, to a network entity, an uplink message associated with a traffic flow having a PDB. The operations of 2105 may be performed in accordance with examples as disclosed herein. In some examples, aspects of the operations of 2105 may be performed by an uplink message transmitter 1135 as described with reference to FIG. 11.

At 2110, the method may include switching a receiver of the UE to a sleep state after transmitting the uplink message, the receiver switching to the sleep state based on the PDB or signaling from the network entity, or both. The operations of 2110 may be performed in accordance with examples as disclosed herein. In some examples, aspects of the operations of 2110 may be performed by a UE receiver state change component 1130 as described with reference to FIG. 11.

At 2115, the method may include receiving, from the network entity, a WUS including an indication that the uplink message was unsuccessfully decoded. The operations of 2115 may be performed in accordance with examples as disclosed herein. In some examples, aspects of the operations of 2115 may be performed by a WUS receiver 1145 as described with reference to FIG. 11.

At 2120, the method may include switching the receiver to an awake state in response to the WUS. The operations of 2120 may be performed in accordance with examples as disclosed herein. In some examples, aspects of the operations of 2120 may be performed by a UE receiver state change component 1130 as described with reference to FIG. 11.

At 2125, the method may include receiving, from the network entity, a control message scheduling a retransmission of the uplink message, the control message received based on monitoring a control channel for the control message while a retransmission timer is active. The operations of 2125 may be performed in accordance with examples as disclosed herein. In some examples, aspects of the operations of 2125 may be performed by a UE receiver state change indication component 1140 as described with reference to FIG. 11.

At 2130, the method may include transmitting, to the network entity, the retransmission of the uplink message in accordance with the control message. The operations of 2130 may be performed in accordance with examples as disclosed herein. In some examples, aspects of the operations of 2130 may be performed by a retransmission transmitter 1160 as described with reference to FIG. 11.

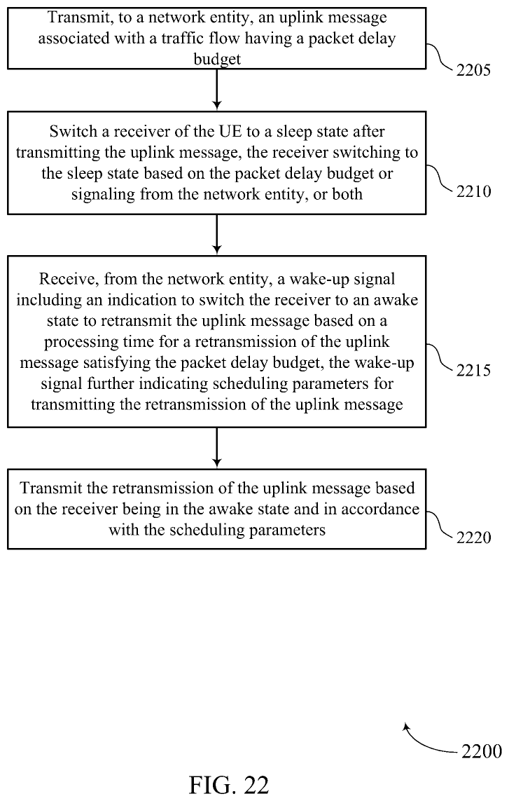

FIG. 22 shows a flowchart illustrating a method 2200 that supports dynamic monitoring of retransmission scheduling according to PDBs in accordance with aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2205, the method may include transmitting, to a network entity, an uplink message associated with a traffic flow having a PDB. The operations of 2205 may be performed in accordance with examples as disclosed herein. In some examples, aspects of the operations of 2205 may be performed by an uplink message transmitter 1135 as described with reference to FIG. 11.

At 2210, the method may include switching a receiver of the UE to a sleep state after transmitting the uplink message, the receiver switching to the sleep state based on the PDB or signaling from the network entity, or both. The operations of 2210 may be performed in accordance with examples as disclosed herein. In some examples, aspects of the operations of 2210 may be performed by a UE receiver state change component 1130 as described with reference to FIG. 11.

At 2215, the method may include receiving, from the network entity, a WUS including an indication to switch the receiver to an awake state to retransmit the uplink message based on a processing time for a retransmission of the uplink message satisfying the PDB, the WUS further indicating scheduling parameters for transmitting the retransmission of the uplink message. The operations of 2215 may be performed in accordance with examples as disclosed herein. In some examples, aspects of the operations of 2215 may be performed by a WUS receiver 1145 as described with reference to FIG. 11.

At 2220, the method may include transmitting the retransmission of the uplink message based on the receiver being in the awake state and in accordance with the scheduling parameters. The operations of 2220 may be performed in accordance with examples as disclosed herein. In some examples, aspects of the operations of 2220 may be performed by a retransmission transmitter 1160 as described with reference to FIG. 11.

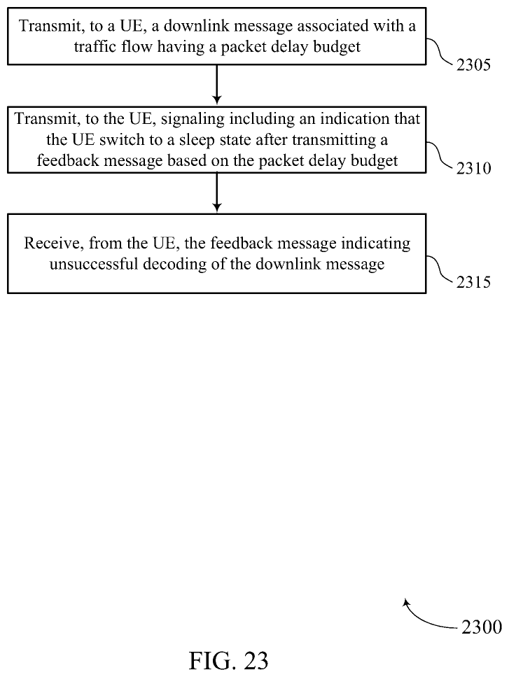

FIG. 23 shows a flowchart illustrating a method 2300 that supports dynamic monitoring of retransmission scheduling according to PDBs in accordance with aspects of the present disclosure. The operations of the method 2300 may be implemented by a network entity or its components as described herein. For example, the operations of the method 2300 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2305, the method may include transmitting, to a UE, a downlink message associated with a traffic flow having a PDB. The operations of 2305 may be performed in accordance with examples as disclosed herein. In some examples, aspects of the operations of 2305 may be performed by a downlink message transmitter 1525 as described with reference to FIG. 15.

At 2310, the method may include transmitting, to the UE, signaling including that the UE switch to a sleep state after transmitting a feedback message based on the PDB. The operations of 2310 may be performed in accordance with examples as disclosed herein. In some examples, aspects of the operations of 2310 may be performed by a UE receiver state change manager 1535 as described with reference to FIG. 15.

At 2315, the method may include receiving, from the UE, the feedback message indicating unsuccessful decoding of the downlink message. The operations of 2315 may be performed in accordance with examples as disclosed herein. In some examples, aspects of the operations of 2315 may be performed by a feedback message receiver 1530 as described with reference to FIG. 15.

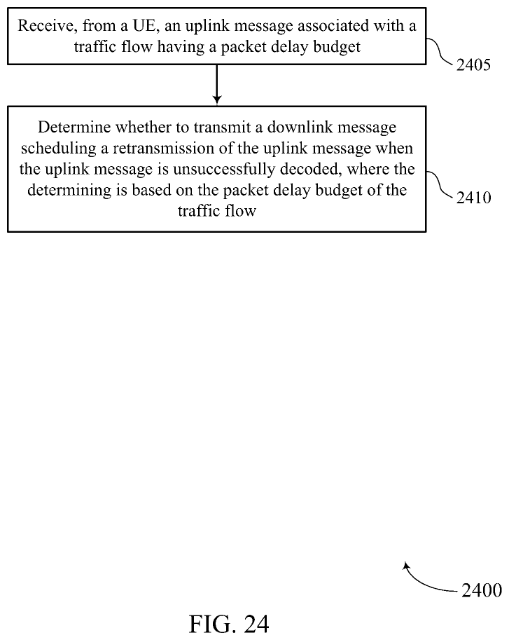

FIG. 24 shows a flowchart illustrating a method 2400 that supports dynamic monitoring of retransmission scheduling according to PDBs in accordance with aspects of the present disclosure. The operations of the method 2400 may be implemented by a network entity or its components as described herein. For example, the operations of the method 2400 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2405, the method may include receiving, from a UE, an uplink message associated with a traffic flow having a PDB. The operations of 2405 may be performed in accordance with examples as disclosed herein. In some examples, aspects of the operations of 2405 may be performed by an uplink message receiver 1540 as described with reference to FIG. 15.

At 2410, the method may include determining whether to transmit a downlink message scheduling a retransmission of the uplink message when the uplink message is unsuccessfully decoded, where the determining is based on the PDB of the traffic flow. The operations of 2410 may be performed in accordance with examples as disclosed herein. In some examples, aspects of the operations of 2410 may be performed by a retransmission scheduling manager 1545 as described with reference to FIG. 15.

The following provides an overview of aspects of the present disclosure:

Aspect 1: A method for wireless communications at a UE, comprising: transmitting, to a network entity, a feedback message indicating unsuccessful decoding of a downlink message, the downlink message being associated with a traffic flow having a PDB; and switching a receiver of the UE to a sleep state after transmitting the feedback message indicating the unsuccessful decoding, the receiver switching to the sleep state based at least in part on the PDB or signaling from the network entity, or both.

Aspect 2: The method of aspect 1, further comprising: receiving the signaling from the network entity prior to transmitting the feedback message, the signaling comprising an indication to switch the receiver to the sleep state immediately after transmitting the feedback message based at least in part on a processing time for a retransmission of the downlink message exceeding the PDB, wherein the receiver remains in the sleep state until one or more timers expire in accordance with the signaling.

Aspect 3: The method of aspect 2, wherein receiving the signaling comprises: receiving the signaling via DCI that schedules the downlink message.

Aspect 4: The method of any of aspects 1 through 3, further comprising: receiving the signaling from the network entity prior to transmitting the feedback message, the signaling comprising an indication to switch the receiver to the sleep state immediately after transmitting the feedback message when the feedback message indicates the unsuccessful decoding; receiving, from the network entity, a WUS comprising an indication to switch the receiver to an awake state to monitor for a control message scheduling a retransmission of the downlink message and monitor for the retransmission of the downlink message based at least in part on a processing time for the retransmission of the downlink message satisfying the PDB; switching the receiver to the awake state in response to the WUS receiving the control message scheduling the retransmission of the downlink message while a retransmission timer is active; and receiving, from the network entity, the retransmission of the downlink message based at least in part on the receiver being in the awake state, wherein the retransmission is received in accordance with the control message.

Aspect 5: The method of aspect 4, wherein the receiver is switched to the awake state in accordance with an interval after receiving the WUS.

Aspect 6: The method of any of aspects 4 through 5, wherein receiving the signaling comprises: receiving a RRC message or a MAC-CE, or both, indicating a configuration to switch the receiver to the sleep state immediately after transmitting the feedback message.

Aspect 7: The method of any of aspects 1 through 6, further comprising: receiving, from the network entity, a WUS including an indication to switch the receiver to an awake state to monitor for a retransmission of the downlink message based at least in part on a processing time for the retransmission of the downlink message satisfying the PDB, the WUS further indicating scheduling parameters for receiving the retransmission of the downlink message; and receiving the retransmission of the downlink message based at least in part on the receiver being in the awake state and in accordance with the scheduling parameters.

Aspect 8: The method of any of aspects 1 through 7, wherein the receiver is in an awake state immediately after transmitting the feedback message and while one or more timers are active, the method further comprising: receiving the signaling from the network entity, the signaling comprising a WUS including an indication that a retransmission of the downlink message is canceled based at least in part on a processing time for the retransmission of the downlink message exceeding the PDB, wherein the receiver is switched to the sleep state in response to the WUS.

Aspect 9: The method of any of aspects 1 through 8, wherein the receiver is in an awake state immediately after transmitting the feedback message and while one or more timers are active, the method further comprising: receiving the signaling from the network entity, the signaling comprising an indication that a retransmission of the downlink message is canceled based at least in part on the UE performing one or more measurements during at least one measurement gap and a processing time for the retransmission of the downlink message exceeding the PDB based at least in part on the one or more measurements, wherein the receiver is switched to the sleep state in response to the signaling.

Aspect 10: The method of aspect 9, wherein the signaling comprises DCI, or a WUS, or both.

Aspect 11: The method of any of aspects 9 through 10, further comprising: transmitting, to the network entity, an uplink message indicating that the UE is to perform the one or more measurements, wherein the indication that the retransmission of the downlink message is canceled is in response to the uplink message.

Aspect 12: The method of aspect 11, wherein the uplink message requests that the retransmission of the downlink message be canceled based at least in part on the PDB.

Aspect 13: The method of any of aspects 11 through 12, wherein the receiver is switched to the sleep state immediately after transmitting the uplink message.

Aspect 14: The method of any of aspects 11 through 13, further comprising: receiving, from the network entity, a message comprising an indication to select a measurement pattern from a set of measurement patterns based at least in part on the PDB, wherein the measurement pattern supports a processing time for the retransmission of the downlink message that satisfies the PDB.

Aspect 15: A method for wireless communications at a UE, comprising: transmitting, to a network entity, an uplink message associated with a traffic flow having a PDB; and switching a receiver of the UE to a sleep state after transmitting the uplink message, the receiver switching to the sleep state based at least in part on the PDB or signaling from the network entity, or both.

Aspect 16: The method of aspect 15, further comprising: transmitting, to the network entity, a control signal comprising an indication that the receiver will switch to the sleep state immediately after transmitting the uplink message based at least in part on a processing time for a retransmission of the uplink message exceeding the PDB, wherein the receiver remains in the sleep state until one or more timers expire based at least in part on the PDB.

Aspect 17: The method of aspect 16, wherein transmitting the control signal comprises: transmitting the control signal via UCI, wherein the indication comprises a one-bit indicator included in the UCI.

Aspect 18: The method of aspect 17, wherein the UCI is multiplexed with the uplink message.

Aspect 19: The method of any of aspects 15 through 18, further comprising: receiving, from the network entity, a WUS comprising an indication that the uplink message was unsuccessfully decoded; switching the receiver to an awake state in response to the WUS; receiving, from the network entity, a control message scheduling a retransmission of the uplink message, the control message received based at least in part on monitoring a control channel for the control message while a retransmission timer is active; and transmitting, to the network entity, the retransmission of the uplink message in accordance with the control message.

Aspect 20: The method of aspect 19, further comprising: determining to retransmit the uplink message as a full copy of the uplink message or a portion of the uplink message to be merged with the uplink message initially transmitted to the network entity, the determination being based at least in part on the PDB, wherein the retransmission of the uplink message comprising the full copy of the uplink message or the portion of the uplink message in accordance with the determination.

Aspect 21: The method of any of aspects 15 through 20, further comprising: receiving, from the network entity, a WUS including an indication to switch the receiver to an awake state to retransmit the uplink message based at least in part on a processing time for a retransmission of the uplink message satisfying the PDB, the WUS further indicating scheduling parameters for transmitting the retransmission of the uplink message; and transmitting the retransmission of the uplink message based at least in part on the receiver being in the awake state and in accordance with the scheduling parameters.

Aspect 22: The method of any of aspects 15 through 21, wherein the receiver is in an awake state immediately after transmitting the uplink message and while one or more timers are active, the method further comprising: receiving the signaling from the network entity, the signaling comprising a WUS including an indication that a retransmission of the uplink message is canceled based at least in part on a processing time for the retransmission of the uplink message exceeding the PDB, wherein the receiver is switched to the sleep state in response to the WUS.

Aspect 23: The method of aspect 22, further comprising: transmitting, to the network entity, an indication of the PDB associated with the traffic flow, wherein the indication that the retransmission of the uplink message is canceled is based at least in part on the indication of the PDB.

Aspect 24: A method for wireless communications at a network entity, comprising: transmitting, to a UE, a downlink message associated with a traffic flow having a PDB; transmitting, to the UE, signaling comprising an indication that the UE switch to a sleep state after transmitting a feedback message based at least in part on the PDB; and receiving, from the UE, the feedback message indicating unsuccessful decoding of the downlink message.

Aspect 25: The method of aspect 24, wherein transmitting the signaling comprises: transmitting the signaling to the UE prior to receiving the feedback message, the signaling comprising an indication to switch the receiver to the sleep state immediately after transmitting the feedback message based at least in part on a processing time for a retransmission of the downlink message exceeding the PDB.

Aspect 26: The method of aspect 25, wherein the signaling is transmitted via DCI that schedules the downlink message.

Aspect 27: The method of any of aspects 24 through 26, wherein transmitting the signaling comprises: transmitting the signaling to the UE prior to receiving the feedback message, the signaling comprising an indication to switch to the sleep state immediately after transmitting the feedback message when the feedback message indicates the unsuccessful decoding, the method further comprising: transmitting, to the UE, a WUS comprising an indication to switch to an awake state to monitor for a control message scheduling a retransmission of the downlink message and monitor for the retransmission of the downlink message based at least in part on a processing time for the retransmission of the downlink message satisfying the PDB transmitting the control message scheduling the retransmission of the downlink message while a retransmission timer is active; and transmitting the retransmission of the downlink message to the UE in accordance with the control message.

Aspect 28: The method of aspect 27, wherein the retransmission of the downlink message is transmitted in accordance with an interval after transmitting the WUS.

Aspect 29: The method of any of aspects 27 through 28, wherein transmitting the signaling comprises: transmitting a RRC message or a MAC-CE, or both, indicating a configuration to switch to the sleep state immediately after transmitting the feedback message.

Aspect 30: The method of any of aspects 24 through 29, further comprising: transmitting, to the UE, a WUS including an indication to switch to an awake state to monitor for a retransmission of the downlink message based at least in part on a processing time for the retransmission of the downlink message satisfying the PDB, the WUS further indicating scheduling parameters for receiving the retransmission of the downlink message; and transmitting the retransmission of the downlink message in accordance with the scheduling parameters.

Aspect 31: The method of any of aspects 24 through 30, wherein the signaling comprises a WUS including an indication that a retransmission of the downlink message is canceled based at least in part on a processing time for the retransmission of the downlink message exceeding the PDB.

Aspect 32: The method of any of aspects 24 through 31, wherein the signaling comprises an indication that a retransmission of the downlink message is canceled based at least in part on the UE performing one or more measurements during at least one measurement gap and a processing time for the retransmission of the downlink message exceeding the PDB based at least in part on the one or more measurements.

Aspect 33: A method for wireless communications at a network entity, comprising: receiving, from a UE, an uplink message associated with a traffic flow having a PDB; and determining whether to transmit a downlink message scheduling a retransmission of the uplink message when the uplink message is unsuccessfully decoded, wherein the determining is based at least in part on the PDB of the traffic flow.

Aspect 34: The method of aspect 33, further comprising: receiving, from the UE, a control signal comprising an indication that the UE will switch to a sleep state immediately after transmitting the uplink message and until one or more timers expire based at least in part on a processing time for the retransmission of the uplink message exceeding the PDB; and determining to refrain from transmitting the downlink message based at least in part on receiving the control signal.

Aspect 35: The method of aspect 34, wherein receiving the control signal comprises: receiving the control signal via UCI, wherein the indication comprises a one-bit indicator included in the UCI.

Aspect 36: The method of aspect 35, wherein the UCI is multiplexed with the uplink message.

Aspect 37: The method of any of aspects 33 through 36, further comprising: transmitting, to the UE, a WUS comprising an indication that the uplink message was unsuccessfully decoded; transmitting, to the UE, the downlink message scheduling the retransmission of the uplink message, the downlink message transmitted while a retransmission timer is active at the UE; and receiving, from the UE, the retransmission of the uplink message in accordance with the downlink message.

Aspect 38: The method of aspect 37, wherein the retransmission of the uplink message comprises a full copy of the uplink message or a portion of the uplink message to be merged with the uplink message initially transmitted by the UE based at least in part on the PDB.

Aspect 39: The method of any of aspects 33 through 38, further comprising: transmitting, to the UE, a WUS including an indication to switch to an awake state to retransmit the uplink message based at least in part on a processing time for the retransmission of the uplink message satisfying the PDB, the WUS further indicating scheduling parameters for transmitting the retransmission of the uplink message; and receiving the retransmission of the uplink message in accordance with the scheduling parameters.

Aspect 40: The method of any of aspects 33 through 39, further comprising: transmitting signaling to the UE, the signaling comprising a WUS including an indication that the retransmission of the uplink message is canceled based at least in part on a processing time for the retransmission of the uplink message exceeding the PDB.

Aspect 41: The method of aspect 40, further comprising: receiving, from the UE, an indication of the PDB associated with the traffic flow, wherein the indication that the retransmission of the uplink message is canceled is based at least in part on the indication of the PDB.

Aspect 42: A UE for wireless communications, comprising one or more memories storing processor-executable code; one or more processors coupled with the one or more memories and individually or collectively operable to execute the code to cause the UE to perform a method of any of aspects 1 through 14.

Aspect 43: A UE for wireless communications, comprising at least one means for performing a method of any of aspects 1 through 14.

Aspect 44: A non-transitory computer-readable medium storing code for wireless communications, the code comprising instructions executable by one or more processors to perform a method of any of aspects 1 through 14.

Aspect 45: A UE for wireless communications, comprising one or more memories storing processor-executable code; one or more processors coupled with the one or more memories and individually or collectively operable to execute the code to cause the UE to perform a method of any of aspects 15 through 23.

Aspect 46: A UE for wireless communications, comprising at least one means for performing a method of any of aspects 15 through 23.

Aspect 47: A non-transitory computer-readable medium storing code for wireless communications, the code comprising instructions executable by one or more processors to perform a method of any of aspects 15 through 23.

Aspect 48: A network entity for wireless communications, comprising one or more memories storing processor-executable code; one or more processors coupled with the one or more memories and individually or collectively operable to execute the code to cause the network entity to perform a method of any of aspects 24 through 32.

Aspect 49: A network entity for wireless communications, comprising at least one means for performing a method of any of aspects 24 through 32.

Aspect 50: A non-transitory computer-readable medium storing code for wireless communications, the code comprising instructions executable by one or more processors to perform a method of any of aspects 24 through 32.

Aspect 51: A network entity for wireless communications, comprising one or more memories storing processor-executable code; one or more processors coupled with the one or more memories and individually or collectively operable to execute the code to cause the network entity to perform a method of any of aspects 33 through 41.

Aspect 52: A network entity for wireless communications, comprising at least one means for performing a method of any of aspects 33 through 41.

Aspect 53: A non-transitory computer-readable medium storing code for wireless communications, the code comprising instructions executable by one or more processors to perform a method of any of aspects 33 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communications comprising:
one or more memories storing processor-executable code; and
one or more processors coupled with the one or more memories and individually or collectively operable to execute the code to cause the UE to:
transmit, to a network entity, a feedback message indicating unsuccessful decoding of a downlink message, the downlink message being associated with a traffic flow having a packet delay budget; and
switch a receiver of the UE to a sleep state after transmitting the feedback message indicating the unsuccessful decoding, the receiver switching to the sleep state based at least in part on the packet delay budget or signaling from the network entity, or both.

2. The UE of claim 1, wherein the one or more processors are individually or collectively further operable to execute the code to cause the UE to:
receive the signaling from the network entity prior to transmitting the feedback message, the signaling comprising an indication to switch the receiver to the sleep state immediately after transmitting the feedback message based at least in part on a processing time for a retransmission of the downlink message exceeding the packet delay budget, wherein the receiver remains in the sleep state until one or more timers expire in accordance with the signaling.

3. The UE of claim 2, wherein, to receive the signaling, the one or more processors are individually or collectively operable to execute the code to cause the UE to:
receive the signaling via downlink control information that schedules the downlink message.

4. The UE of claim 1, wherein the one or more processors are individually or collectively further operable to execute the code to cause the UE to:
receive the signaling from the network entity prior to transmitting the feedback message, the signaling comprising an indication to switch the receiver to the sleep state immediately after transmitting the feedback message when the feedback message indicates the unsuccessful decoding;
receive, from the network entity, a wake-up signal comprising an indication to switch the receiver to an awake state to monitor for a control message scheduling a retransmission of the downlink message and monitor for the retransmission of the downlink message based at least in part on a processing time for the retransmission of the downlink message satisfying the packet delay budget;
switch the receiver to the awake state in response to the wake-up signal;
receive the control message scheduling the retransmission of the downlink message while a retransmission timer is active; and
receive, from the network entity, the retransmission of the downlink message based at least in part on the receiver being in the awake state, wherein the retransmission is received in accordance with the control message.

5. The UE of claim 4, wherein the receiver is switched to the awake state in accordance with an interval after receiving the wake-up signal.

6. The UE of claim 4, wherein, to receive the signaling, the one or more processors are individually or collectively operable to execute the code to cause the UE to:
receive a radio resource control message or a medium access control-control element, or both, indicating a configuration to switch the receiver to the sleep state immediately after transmitting the feedback message.

7. The UE of claim 1, wherein the one or more processors are individually or collectively further operable to execute the code to cause the UE to:
receive, from the network entity, a wake-up signal including an indication to switch the receiver to an awake state to monitor for a retransmission of the downlink message based at least in part on a processing time for the retransmission of the downlink message satisfying the packet delay budget, the wake-up signal further indicating scheduling parameters for receiving the retransmission of the downlink message; and
receive the retransmission of the downlink message based at least in part on the receiver being in the awake state and in accordance with the scheduling parameters.

8. The UE of claim 1, wherein the receiver is in an awake state immediately after transmitting the feedback message and while one or more timers are active, and the one or more processors are individually or collectively operable to execute the code to cause the UE to:
receive the signaling from the network entity, the signaling comprising a wake-up signal including an indication that a retransmission of the downlink message is canceled based at least in part on a processing time for the retransmission of the downlink message exceeding the packet delay budget, wherein the receiver is switched to the sleep state in response to the wake-up signal.

9. The UE of claim 1, wherein the receiver is in an awake state immediately after transmitting the feedback message and while one or more timers are active, and the one or more processors are individually or collectively operable to execute the code to cause the UE to:
receive the signaling from the network entity, the signaling comprising an indication that a retransmission of the downlink message is canceled based at least in part on the UE performing one or more measurements during at least one measurement gap and a processing time for the retransmission of the downlink message exceeding the packet delay budget based at least in part on the one or more measurements, wherein the receiver is switched to the sleep state in response to the signaling.

10. The UE of claim 9, wherein the signaling comprises downlink control information, or a wake-up signal, or both.

11. The UE of claim 9, wherein the one or more processors are individually or collectively further operable to execute the code to cause the UE to:
transmit, to the network entity, an uplink message indicating that the UE is to perform the one or more measurements, wherein the indication that the retransmission of the downlink message is canceled is in response to the uplink message.

12. (canceled)

13. (canceled)

14. (canceled)

15. A user equipment (UE) for wireless communications comprising:
one or more memories storing processor-executable code; and
one or more processors coupled with the one or more memories and individually or collectively operable to execute the code to cause the UE to:
transmit, to a network entity, an uplink message associated with a traffic flow having a packet delay budget; and
switch a receiver of the UE to a sleep state after transmitting the uplink message, the receiver switching to the sleep state based at least in part on the packet delay budget or signaling from the network entity, or both.

16. The UE of claim 15, wherein the one or more processors are individually or collectively further operable to execute the code to cause the UE to:
transmit, to the network entity, a control signal comprising an indication that the receiver will switch to the sleep state immediately after transmitting the uplink message based at least in part on a processing time for a retransmission of the uplink message exceeding the packet delay budget, wherein the receiver remains in the sleep state until one or more timers expire based at least in part on the packet delay budget.

17. (canceled)

18. (canceled)

19. The UE of claim 15, wherein the one or more processors are individually or collectively further operable to execute the code to cause the UE to:
receive, from the network entity, a wake-up signal comprising an indication that the uplink message was unsuccessfully decoded;
switch the receiver to an awake state in response to the wake-up signal;
receive, from the network entity, a control message scheduling a retransmission of the uplink message, the control message received based at least in part on monitoring a control channel for the control message while a retransmission timer is active; and
transmit, to the network entity, the retransmission of the uplink message in accordance with the control message.

20. (canceled)

21. The UE of claim 15, wherein the one or more processors are individually or collectively further operable to execute the code to cause the UE to:
receive, from the network entity, a wake-up signal including an indication to switch the receiver to an awake state to retransmit the uplink message based at least in part on a processing time for a retransmission of the uplink message satisfying the packet delay budget, the wake-up signal further indicating scheduling parameters for transmitting the retransmission of the uplink message; and
transmit the retransmission of the uplink message based at least in part on the receiver being in the awake state and in accordance with the scheduling parameters.

22. The UE of claim 15, wherein the receiver is in an awake state immediately after transmitting the uplink message and while one or more timers are active, and the one or more processors are individually or collectively operable to execute the code to cause the UE to:
receive the signaling from the network entity, the signaling comprising a wake-up signal including an indication that a retransmission of the uplink message is canceled based at least in part on a processing time for the retransmission of the uplink message exceeding the packet delay budget, wherein the receiver is switched to the sleep state in response to the wake-up signal.

23. (canceled)

24. A network entity for wireless communications comprising:
one or more memories storing processor-executable code; and
one or more processors coupled with the one or more memories and individually or collectively operable to execute the code to cause the network entity to:
transmit, to a user equipment (UE), a downlink message associated with a traffic flow having a packet delay budget;
transmit, to the UE, signaling comprising an indication that the UE switch to a sleep state after transmitting a feedback message based at least in part on the packet delay budget; and
receive, from the UE, the feedback message indicating unsuccessful decoding of the downlink message.

25. The network entity of claim 24, wherein, to transmit the signaling the one or more processors are individually or collectively operable to execute the code to cause the network entity to:
transmit the signaling to the UE prior to receiving the feedback message, the signaling comprising an indication to switch the receiver of the UE to the sleep state immediately after transmitting the feedback message based at least in part on a processing time for a retransmission of the downlink message exceeding the packet delay budget.

26. The network entity of claim 24, wherein, to transmit the signaling, the one or more processors are individually or collectively operable to execute the code to cause the network entity to:
transmit the signaling to the UE prior to receiving the feedback message, the signaling comprising an indication to switch to the sleep state immediately after transmitting the feedback message when the feedback message indicates the unsuccessful decoding, wherein the one or more processors are individually or collectively further operable to execute the code to cause the network entity to:
transmit, to the UE, a wake-up signal comprising an indication to switch to an awake state to monitor for a control message scheduling a retransmission of the downlink message and monitor for the retransmission of the downlink message based at least in part on a processing time for the retransmission of the downlink message satisfying the packet delay budget;
transmit the control message scheduling the retransmission of the downlink message while a retransmission timer is active; and
transmit the retransmission of the downlink message to the UE in accordance with the control message.

27. The network entity of claim 24, wherein the one or more processors are individually or collectively further operable to execute the code to cause the network entity to:
transmit, to the UE, a wake-up signal including an indication to switch to an awake state to monitor for a retransmission of the downlink message based at least in part on a processing time for the retransmission of the downlink message satisfying the packet delay budget, the wake-up signal further indicating scheduling parameters for receiving the retransmission of the downlink message; and
transmit the retransmission of the downlink message in accordance with the scheduling parameters.

28. (canceled)

29. (canceled)

30. (canceled)
